(19) United States
(12) Patent Application Publication
(10) Pub. No.: US 2025/0197106 A1
(43) Pub. Date: Jun. 19, 2025

(54) Autonomy Systems and Methods for a Vocational Vehicle

(71) Applicant: Oshkosh Corporation, Oshkosh, WI (US)

(72) Inventors: John Beck, Oshkosh, WI (US); Johnny Bui, Oshkosh, WI (US); Brendan Chan, Oshkosh, WI (US); Eric Jiang, Oshkosh, WI (US); Leo Van Kampen, Conestogo (CA); Eric Olson, Oshkosh, WI (US); Monika Nagalla, Oshkosh, WI (US); Vince Schad, Oshkosh, WI (US); Adam Shufelt, Oshkosh, WI (US); Lincoln Stein, Oshkosh, WI (US); David Stone, Oshkosh, WI (US); Brian Thomas, Oshkosh, WI (US)

(73) Assignee: Oshkosh Corporation, Oshkosh, WI (US)

(21) Appl. No.: 18/980,952

(22) Filed: Dec. 13, 2024

Related U.S. Application Data
(60) Provisional application No. 63/610,103, filed on Dec. 14, 2023.

(51) Int. Cl. B65F 3/14; G01S 13/931

(52) U.S. Cl. CPC B65F 3/14; G01S 13/931

(57) ABSTRACT

A vocational vehicle includes a chassis, a cab supported by the chassis, a body supported by the chassis and defining a compartment, a lift assembly coupled to the body so that the lift assembly is configured to move between a lowered position and a raised position along a path, a sensor defining a field of view that at least partially includes the path of the lift assembly, and a vehicle control system in communication with the lift assembly and the sensor. The vehicle control system includes a controller having a processor and at least one memory. The controller is configured to detect that the lift assembly is activated to move and disable the sensor.

### CROSS-REFERENCE TO RELATED PATENT APPLICATIONS

This application claims the benefit of and priority to U.S. Provisional Patent Application No. 63/610,103, filed Dec. 14, 2023, the entire disclosure of which is incorporated herein by reference in its entirety.

### BACKGROUND

Vocational vehicles are typically controlled to perform a specific task (e.g., refuse collection, concrete mixing, lifting, firefighting, military operations, delivery and transportation, etc.).

### SUMMARY

In some aspects, the present disclosure relates to a vocational vehicle including: a chassis; a cab supported by the chassis; a body supported by the chassis and defining a compartment; a lift assembly coupled to the body so that the lift assembly is configured to move between a lowered position and a raised position along a path; a sensor defining a field of view that at least partially includes the path of the lift assembly; and a vehicle control system in communication with the lift assembly and the sensor, the vehicle control system including a controller having a processor and at least one memory, the controller being configured to: detect that the lift assembly is activated to move; and disable the sensor.

In some aspects, the present disclosure relates to a refuse vehicle including: a chassis; a cab supported by the chassis; a body supported by the chassis and defining a refuse compartment; a lift assembly coupled to the body and including a lift arm actuator that is configured to move the lift assembly between a lowered position and a raised position along a lifting path; a radar sensor defining a field of view that at least partially includes the lifting path of the lift assembly; and a vehicle control system in communication with the lift assembly and the radar sensor, the vehicle control system including a controller having a processor and at least one memory, the controller being configured to: determine that the lift arm actuator is moving the lift assembly along the lifting path; and disable the radar sensor while the lift arm actuator is moving the lift assembly along the lifting path.

In some aspects, the present disclosure relates to a refuse vehicle including: a chassis; a cab supported by the chassis; a body supported by the chassis and defining a refuse compartment; a lift assembly coupled to a front portion of the body and including a lift arm actuator that is configured to move the lift assembly between a lowered position and a raised position along a lifting path; a radar sensor defining a field of view that at least partially includes the lifting path of the lift assembly; a position sensor configured to sense a position of the lift assembly; and a vehicle control system in communication with the lift assembly, the radar sensor, and the position sensor, the vehicle control system including a controller having a processor and at least one memory, the controller being configured to: determine, based on the position sensor, that the lift arm actuator is moving the lift assembly along the lifting path; and disable the radar sensor when the lift assembly is within a predetermined range along the lifting path.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a left side view of a vehicle, according to an exemplary embodiment;

FIG. 2 is a perspective view of a chassis of the vehicle of FIG. 1;

FIG. 3 is a perspective view of the vehicle of FIG. 1 configured as a front-loading refuse vehicle, according to an exemplary embodiment;

FIG. 4 is a left side view of the front-loading refuse vehicle of FIG. 3 configured with a tag axle, according to an exemplary embodiment;

FIG. 5 is a perspective view of the vehicle of FIG. 1 configured as a side-loading refuse vehicle, according to an exemplary embodiment;

FIG. 6 is a right side view of the side-loading refuse vehicle of FIG. 5;

FIG. 7 is a top view of the side-loading refuse vehicle of FIG. 5;

FIG. 8 is a left side view of the side-loading refuse vehicle of FIG. 5 configured with a tag axle, according to an exemplary embodiment;

FIG. 9 is a perspective view of the vehicle of FIG. 1 configured as a mixer vehicle, according to an exemplary embodiment;

FIG. 10 is a perspective view of the vehicle of FIG. 1 configured as a fire fighting vehicle, according to an exemplary embodiment;

FIG. 11 is a left side view of the vehicle of FIG. 1 configured as an airport fire fighting vehicle, according to an exemplary embodiment;

FIG. 12 is a perspective view of the vehicle of FIG. 1 configured as a boom lift, according to an exemplary embodiment;

FIG. 13 is a perspective view of the vehicle of FIG. 1 configured as a scissor lift, according to an exemplary embodiment;

FIG. 14 is a block diagram of a control system for a vehicle, according to an exemplary embodiment;

FIG. 15 is a top view showing a refuse vehicle equipped with an identification system, according to an exemplary embodiment;

FIG. 16 is an illustration of a refuse container including example overlays generated by an identification system of a refuse vehicle, according to an exemplary embodiment;

FIG. 17 is a block diagram of an identification system, according to an exemplary embodiment;

FIG. 18 is a perspective view of a refuse vehicle equipped with an overhead object detection and warning system, according to an exemplary embodiment;

FIG. 19 is an illustration showing the refuse vehicle of FIG. 18 having a lift apparatus disposed at multiple locations during a refuse collection operation, according to an exemplary embodiment;

FIG. 20 is a block diagram of an overhead object detection and warning system, according to an exemplary embodiment;

FIG. 21 is a schematic illustration of a refuse vehicle equipped with a hopper system, according to an exemplary embodiment;

FIG. 22 is a perspective view of a refuse compartment and a hopper volume of a refuse vehicle as seen through a thermal camera, according to an exemplary embodiment;

FIG. 23 is a perspective view of a refuse compartment and a hopper volume of a refuse vehicle including a sensor mounted inside the hopper volume, according to an exemplary embodiment;

FIG. 24 is a perspective view of a refuse compartment and a hopper volume of a refuse vehicle including a sensor mounted inside the hopper volume, according to an exemplary embodiment;

FIG. 25 is a block diagram of a hopper system for a refuse vehicle, according to an exemplary embodiment;

FIG. 26 is a perspective view of a refuse vehicle equipped with a 360-degree detection and warning system such as an advanced driver assistance system, according to an exemplary embodiment;

FIG. 27 is a top view of the refuse vehicle of FIG. 26, according to an exemplary embodiment;

FIG. 28 is an example display illustrating one embodiment of a view from the detection and warning system on the refuse vehicle of FIG. 26 or FIG. 27, according to an exemplary embodiment;

FIG. 29 is a top view of the refuse vehicle of FIG. 26 illustrating a radar detection system integrated into the refuse vehicle, according to an exemplary embodiment;

FIG. 30 is a top view of the refuse vehicle of FIG. 26 illustrating both the 360-degree camera system and the radar detection system integrated into the refuse vehicle, according to an exemplary embodiment;

FIG. 31 is a front perspective view of the refuse vehicle of FIG. 26 including four radar sensors integrated into a front of a cab of the refuse vehicle, according to an exemplary embodiment;

FIG. 32 is a front right side perspective view of the refuse vehicle of FIG. 26 including two radar sensors integrated the cab of the refuse vehicle, according to an exemplary embodiment;

FIG. 33 is a front left side perspective view of the refuse vehicle of FIG. 26 including two radar sensors integrated into the cab of the refuse vehicle, according to an exemplary embodiment;

FIG. 34 is a top view illustrating an example refuse vehicle equipped with an operator location system, according to an example embodiment;

FIG. 35 is a top view illustrating the refuse vehicle of FIG. 34 receiving a location of an operator via the operator location system, according to an exemplary embodiment;

FIG. 36 is a block diagram illustrating the components of an operator location system, according to an exemplary embodiment;

FIG. 37 is a block diagram illustrating the components of a component and/or alarm disabling system, according to an exemplary embodiment;

FIG. 38 is a perspective view of a refuse vehicle equipped with a component and/or alarm disabling system, according to an exemplary embodiment;

FIG. 39 is a block diagram illustrating the components of a collision mitigation system, according to an exemplary embodiment;

FIG. 40 is an illustrating showing a vehicle equipped with a collision mitigation system detecting the presence of a vehicle travelling above a threshold detection speed, according to an exemplary embodiment;

FIG. 41 is a block diagram illustrating the components of a customer support and training system, according to an exemplary embodiment; and

FIG. 42 is a block diagram illustrating the components of a vehicle support system including an AI engine, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, systems and methods disclosed herein provide automated or semi-automated support functionalities to assist in the operating of a vehicle. The vehicle may include a positioning system and/or a route generation/prediction system that includes components such as a global positioning system (GPS) transceiver, a cellular transceiver, inertia sensors, and other sensors that may be integrated or utilized with one or more driver assistance systems. The driver assistance systems may include an identification system, overhead object detection and warning system, a hopper system, a 360-degree detection and warning system, an operator location system, a component and/or alarm disabling system, a collision mitigation system. In this way, the systems and methods disclosed herein may interoperate to streamline a vehicle operation, reduce operator error associated with the vehicle, provide advance warning of hazards during the operation of the vehicle, and/or autonomously control operation of the vehicle.

Further, driver assistance systems disclosed herein may be integrated into one or more vehicles such that the systems are interoperable with each other. For example, one system may communicate, disable, or otherwise interact with a functionality of another system to prevent false alarms, excessive alerts, or otherwise streamline operation of the vehicle. Additionally, a customer support and training system may receive data associated with each system, the vehicle, components thereof, and vehicle operations. The customer support and training system may include a vehicle support system utilizing an AI engine such as a large language model to receive customer/operator queries for information regarding the vehicle. The customer support and training system may autonomously or semi-autonomously generate replies responsive to the customer/operator queries and otherwise provide assistance in response to receiving operator inputs.

### Overall Vehicle

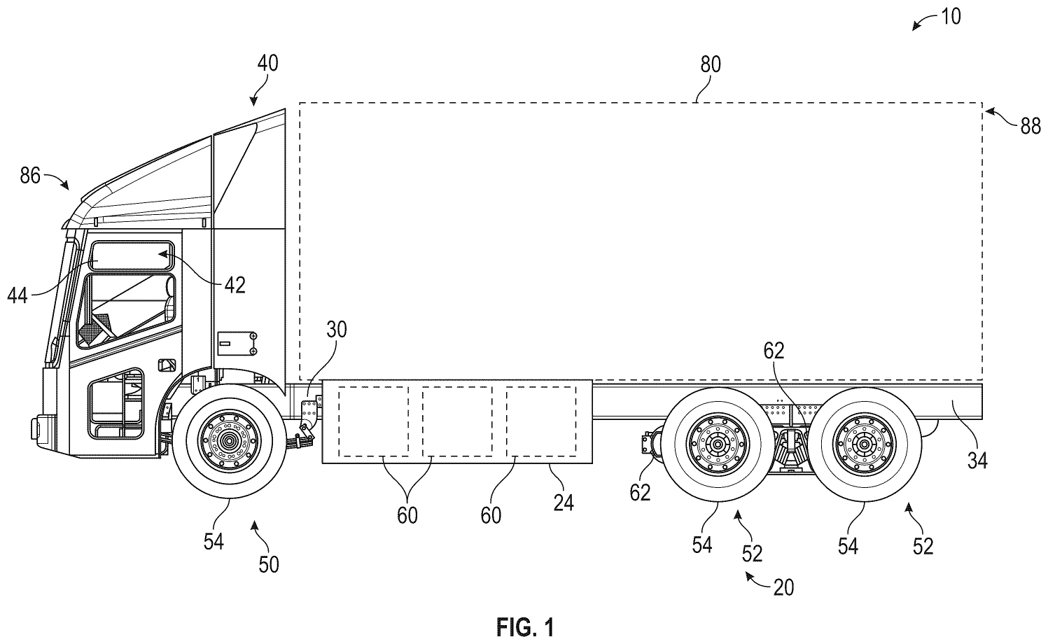

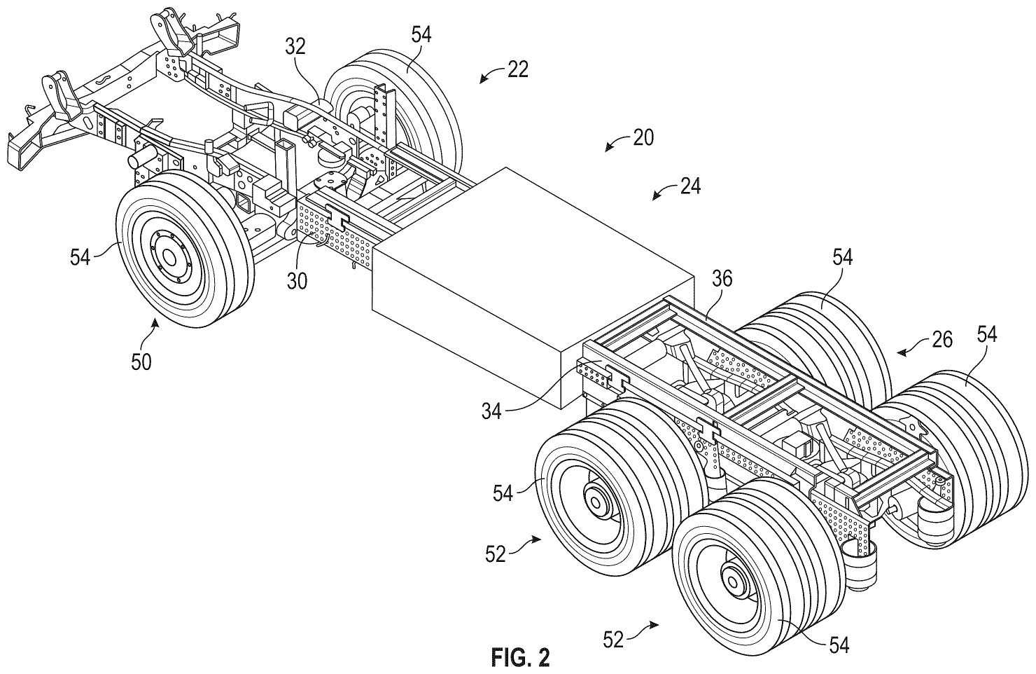

Referring to FIGS. 1 and 2, a vocational vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, joysticks, etc.), and/or user interface components that provide information to the operators (e.g., lights, gauges, speakers, LCD displays, screens, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

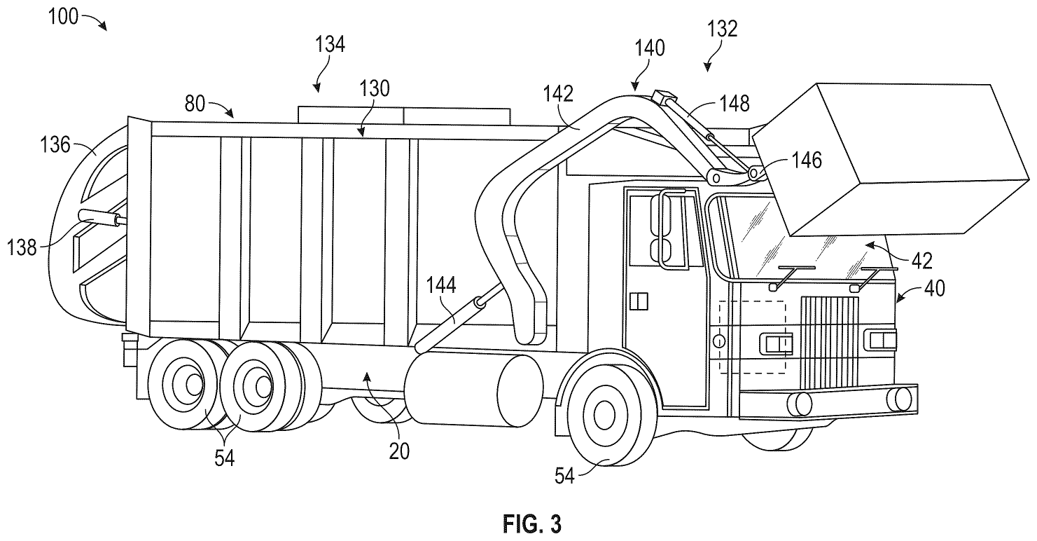

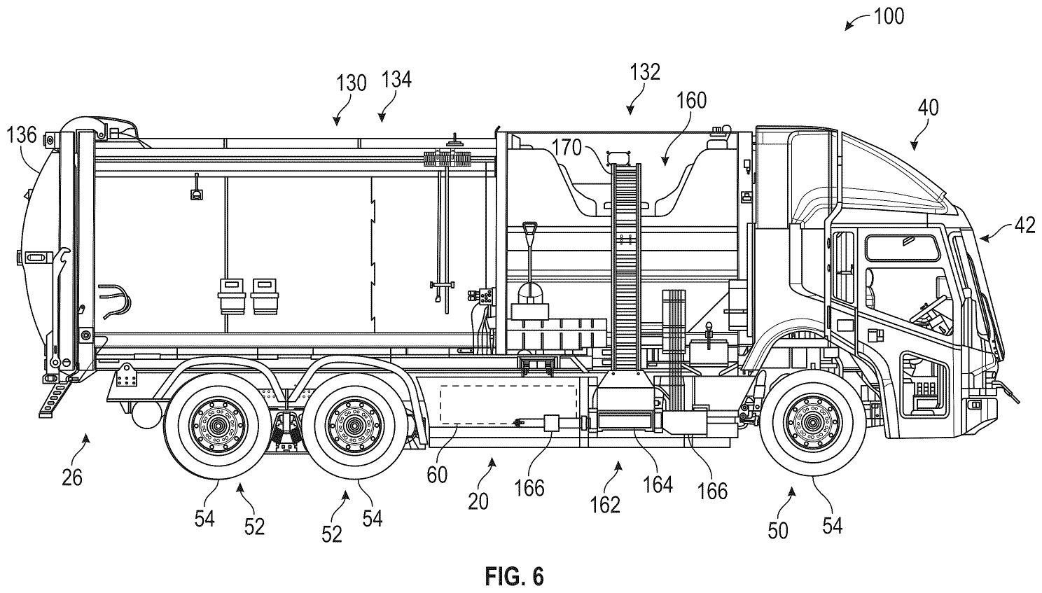

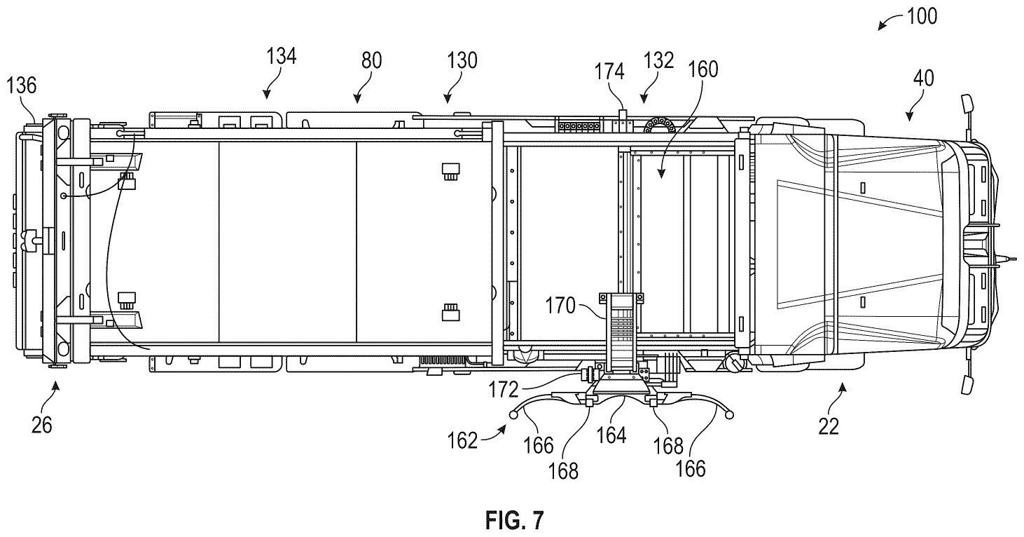

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-13 illustrate various examples of how the vehicle 10 may be configured for specific applications/environments. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

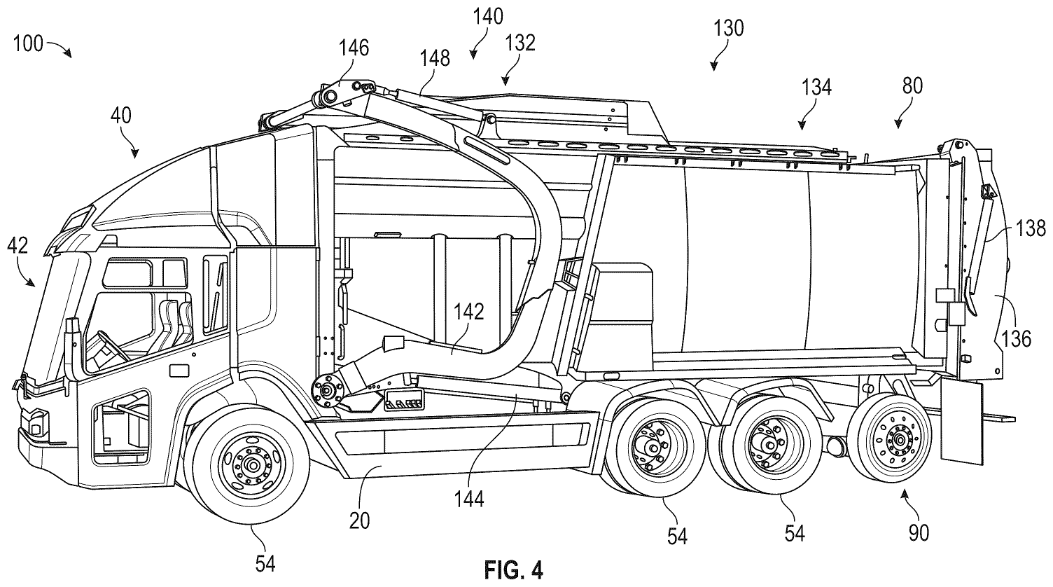

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle, a side-loading refuse vehicle, or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the refuse vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively coupled the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

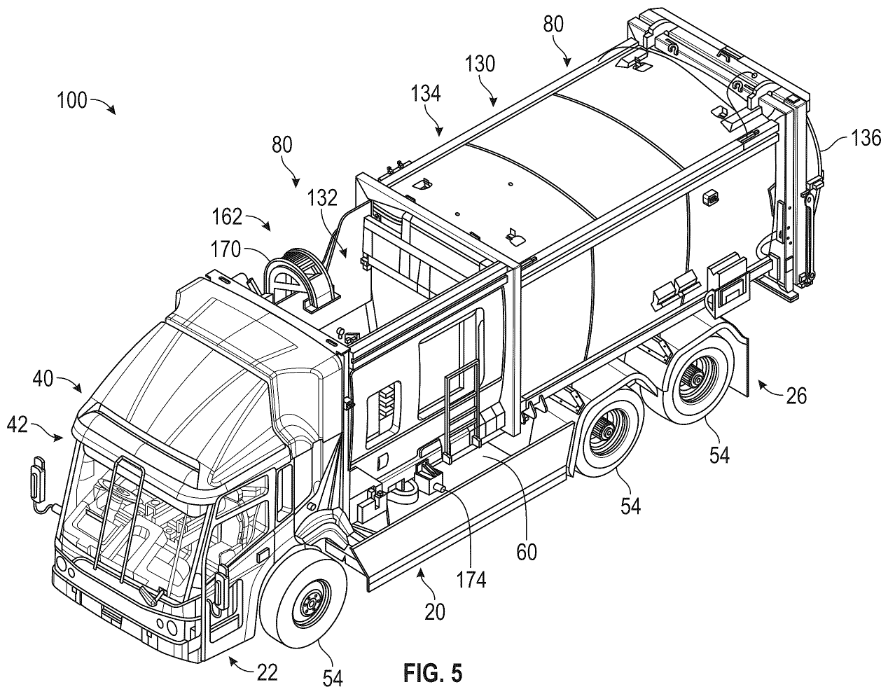

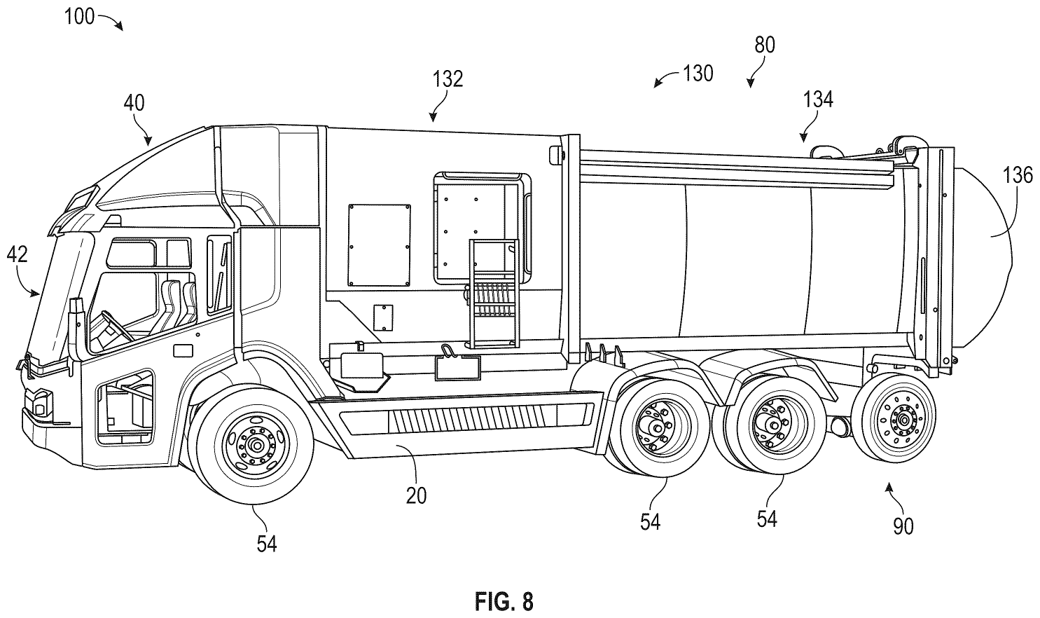

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown, the refuse vehicle 100 of FIGS. 5-7 is configured with a tag axle 90 in FIG. 8.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

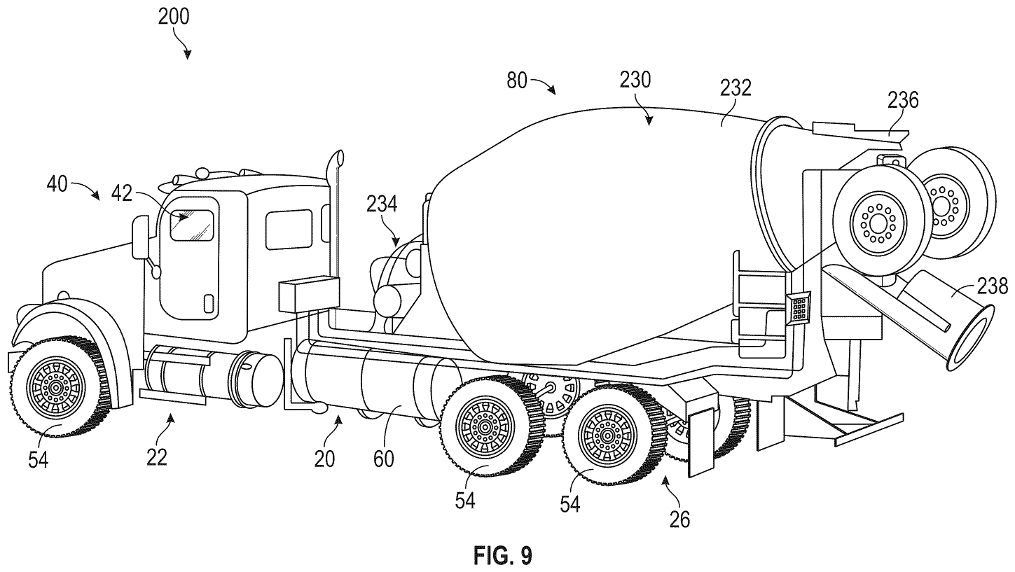

Referring now to FIG. 9, the vehicle 10 is configured as a mixer truck (e.g., a concrete mixer truck, a mixer vehicle, etc.), shown as mixer truck 200. Specifically, the mixer truck 200 is shown as a rear-discharge concrete mixer truck. In other embodiments, the mixer truck 200 is a front-discharge concrete mixer truck.

As shown in FIG. 9, the application kit 80 includes a mixing drum assembly (e.g., a concrete mixing drum), shown as drum assembly 230. The drum assembly 230 may include a mixing drum 232, a drum drive system 234 (e.g., a rotational actuator or motor, such as an electric motor or hydraulic motor), an inlet portion, shown as hopper 236, and an outlet portion, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 may be elevated from the chassis 20 (e.g., from a horizontal plane extending along the chassis 20) at an angle in the range of five degrees to twenty degrees. In other embodiments, the central, longitudinal axis may be elevated by less than five degrees (e.g., four degrees, etc.). In yet another embodiment, the mixer truck 200 may include an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves) including an injection valve that selectively fluidly couples a supply of fluid to the inner volume of the mixing drum 232. By way of example, the injection system may be used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) may be positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 may also include an actuator positioned such that the chute 238 may be selectively pivotable to position the chute 238 (e.g., vertically, laterally, etc.), for example at an angle at which the mixture is expelled from the mixing drum 232.

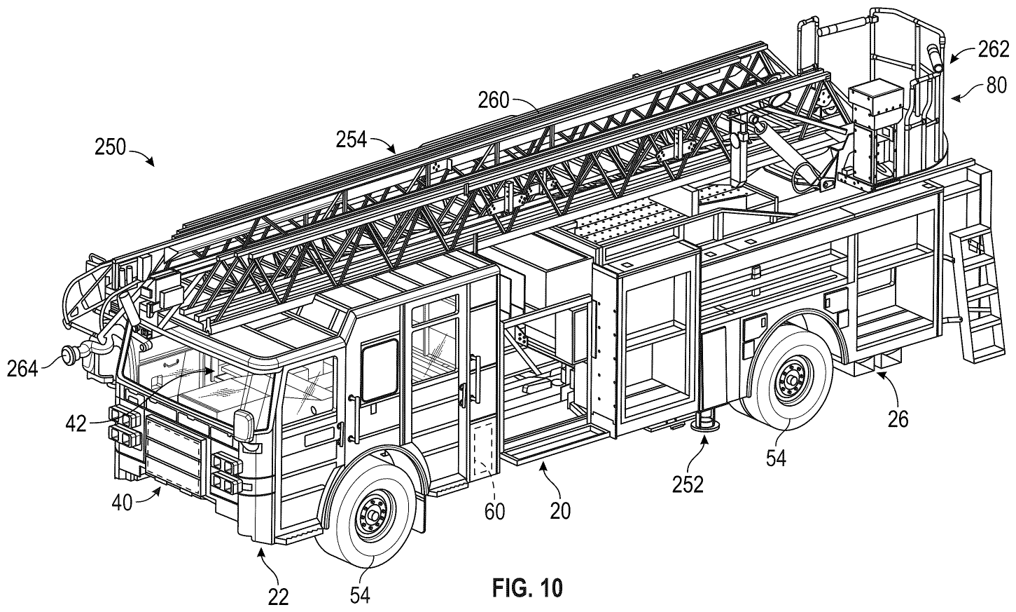

Referring now to FIG. 10, the vehicle 10 is configured as a fire fighting vehicle, fire truck, or fire apparatus (e.g., a turntable ladder truck, a pumper truck, a quint, etc.), shown as fire fighting vehicle 250. In the embodiment shown in FIG. 10, the fire fighting vehicle 250 is configured as a rear-mount aerial ladder truck. In other embodiments, the fire fighting vehicle 250 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. By way of example, the vehicle 10 may be configured as a police vehicle, an ambulance, a tow truck, or still other vehicles used for responding to a scene (e.g., an accident, a fire, an incident, etc.).

As shown in FIG. 10, in the fire fighting vehicle 250, the application kit 80 is positioned mainly rearward from the cab 40. The application kit 80 includes deployable stabilizers (e.g., outriggers, downriggers, etc.), shown as outriggers 252, that are coupled to the chassis 20. The outriggers 252 may be configured to selectively extend from each lateral side and/or the rear of the fire fighting vehicle 250 and engage a support surface (e.g., the ground) in order to provide increased stability while the fire fighting vehicle 250 is stationary. The fire fighting vehicle 250 further includes an extendable or telescoping ladder assembly, shown as ladder assembly 254. The increased stability provided by the outriggers 252 is desirable when the ladder assembly 254 is in use (e.g., extended from the fire fighting vehicle 250) to prevent tipping. In some embodiments, the application kit 80 further includes various storage compartments (e.g., cabinets, lockers, etc.) that may be selectively opened and/or accessed for storage and/or component inspection, maintenance, and/or replacement.

As shown in FIG. 10, the ladder assembly 254 includes a series of ladder sections 260 that are slidably coupled with one another such that the ladder sections 260 may extend and/or retract (e.g., telescope) relative to one another to selectively vary a length of the ladder assembly 254. A base platform, shown as turntable 262, is rotatably coupled to the chassis 20 and to a proximal end of a base ladder section 260 (i.e., the most proximal of the ladder sections 260). The turntable 262 may be configured to rotate about a vertical axis relative to the chassis 20 to rotate the ladder sections 260 about the vertical axis (e.g., up to 360 degrees, etc.). The ladder sections 260 may rotate relative to the turntable 262 about a substantially horizontal axis to selectively raise and lower the ladder sections 260 relative to the chassis 20. As shown, a water turret or implement, shown as monitor 264, is coupled to a distal end of a fly ladder section 260 (i.e., the most distal of the ladder sections 260). The monitor 264 may be configured to expel water and/or a fire suppressing agent (e.g., foam, etc.) from a water storage tank and/or an agent tank onboard the fire fighting vehicle 250, and/or from an external source (e.g., a fire hydrant, a separate water/pumper truck, etc.). In some embodiments, the ladder assembly 254 further includes an aerial platform coupled to the distal end of the fly ladder section 260 and configured to support one or more operators.

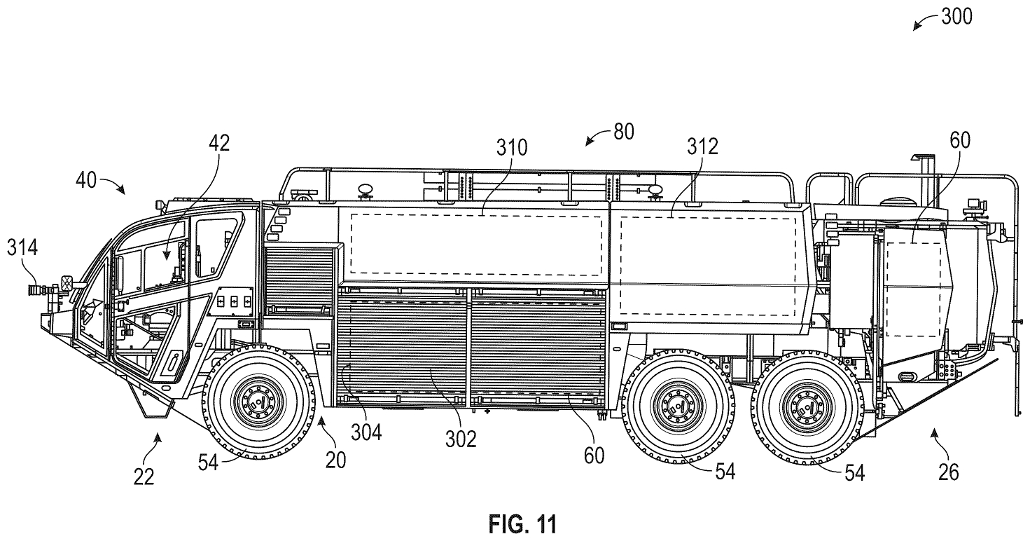

Referring now to FIG. 11, the vehicle 10 is configured as a fire fighting vehicle, shown as airport rescue and fire fighting (ARFF) truck 300. As shown in FIG. 11, the application kit 80 is positioned primarily rearward of the cab 40. As shown, the application kit 80 includes a series of storage compartments or cabinets, shown as compartments 302, that are coupled to the chassis 20. The compartments 302 may store various equipment or components of the ARFF truck 300.

The application kit 80 includes a pump system 304 (e.g., an ultra-high-pressure pump system, etc.) positioned within one of the compartments 302 near the center of the ARFF truck 300. The application kit 80 further includes a water tank 310, an agent tank 312, and an implement or water turret, shown as monitor 314. The pump system 304 may include a high pressure pump and/or a low pressure pump, which may be fluidly coupled to the water tank 310 and/or the agent tank 312. The pump system 304 may to pump water and/or fire suppressing agent from the water tank 310 and the agent tank 312, respectively, to the monitor 314. The monitor 314 may be selectively reoriented by an operator to adjust a direction of a stream of water and/or agent. As shown in FIG. 11, the monitor 314 is coupled to a front end of the cab 40.

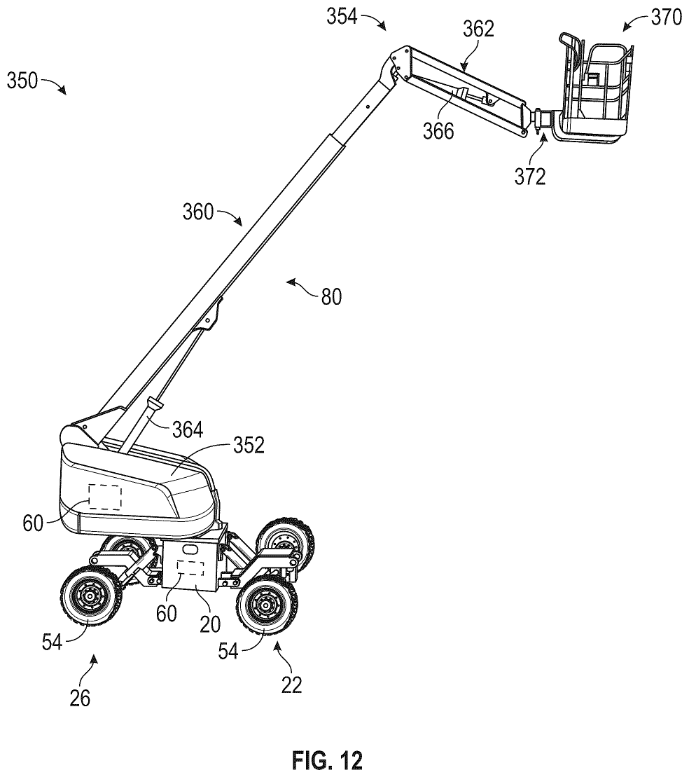

Referring now to FIG. 12, the vehicle 10 is configured as a lift device, shown as boom lift 350. The boom lift 350 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 12, the application kit 80 includes a base assembly, shown as turntable 352, that is rotatably coupled to the chassis 20. The turntable 352 may be configured to selectively rotate relative to the chassis 20 about a substantially vertical axis. In some embodiments, the turntable 352 includes a counterweight (e.g., the batteries) positioned near the rear of the turntable 352. The turntable 352 is rotatably coupled to a lift assembly, shown as boom assembly 354. The boom assembly 354 includes a first section or telescoping boom section, shown as lower boom 360. The lower boom 360 includes a series of nested boom sections that extend and retract (e.g., telescope) relative to one another to vary a length of the boom assembly 354. The boom assembly 354 further includes a second boom section or four bar linkage, shown as upper boom 362. The upper boom 362 may include structural members that rotate relative to one another to raise and lower a distal end of the boom assembly 354. In other embodiments, the boom assembly 354 includes more or fewer boom sections (e.g., one, three, five, etc.) and/or a different arrangement of boom sections.

As shown in FIG. 12, the boom assembly 354 includes a first actuator, shown as lower lift cylinder 364. The lower boom 360 is pivotally coupled (e.g., pinned, etc.) to the turntable 352 at a joint or lower boom pivot point. The lower lift cylinder 364 (e.g., a pneumatic cylinder, an electric linear actuator, a hydraulic cylinder, etc.) is coupled to the turntable 352 at a first end and coupled to the lower boom 360 at a second end. The lower lift cylinder 364 may be configured to raise and lower the lower boom 360 relative to the turntable 352 about the lower boom pivot point.

The boom assembly 354 further includes a second actuator, shown as upper lift cylinder 366. The upper boom 362 is pivotally coupled (e.g., pinned) to the upper end of the lower boom 360 at a joint or upper boom pivot point. The upper lift cylinder 366 (e.g., a pneumatic cylinder, an electric linear actuator, a hydraulic cylinder, etc.) is coupled to the upper boom 362. The upper lift cylinder 366 may be configured to extend and retract to actuate (e.g., lift, rotate, elevate, etc.) the upper boom 362, thereby raising and lowering a distal end of the upper boom 362.

Referring still to FIG. 12, the application kit 80 further includes an operator platform, shown as platform assembly 370, coupled to the distal end of the upper boom 362 by an extension arm, shown as jib arm 372. The jib arm 372 may be configured to pivot the platform assembly 370 about a lateral axis (e.g., to move the platform assembly 370 up and down, etc.) and/or about a vertical axis (e.g., to move the platform assembly 370 left and right, etc.).

The platform assembly 370 provides a platform configured to support one or more operators or users. In some embodiments, the platform assembly 370 may include accessories or tools configured for use by the operators. For example, the platform assembly 370 may include pneumatic tools (e.g., an impact wrench, airbrush, nail gun, ratchet, etc.), plasma cutters, welders, spotlights, etc. In some embodiments, the platform assembly 370 includes a control panel (e.g., a user interface, a removable or detachable control panel, etc.) configured to control operation of the boom lift 350 (e.g., the turntable 352, the boom assembly 354, etc.) from the platform assembly 370 or remotely. In other embodiments, the platform assembly 370 is omitted, and the boom lift 350 includes an accessory and/or tool (e.g., forklift forks, etc.) coupled to the distal end of the boom assembly 354.

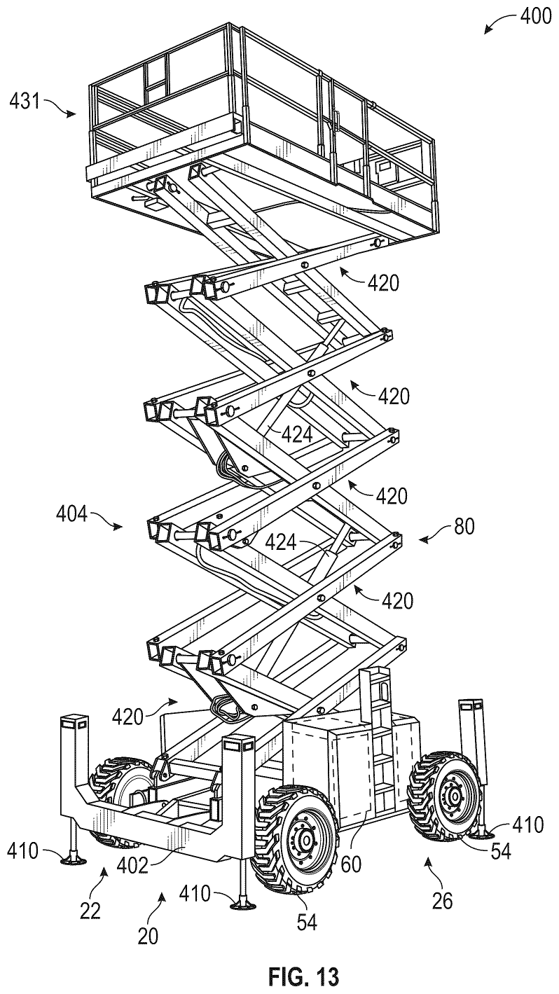

Referring now to FIG. 13, the vehicle 10 is configured as a lift device, shown as scissor lift 400. As shown in FIG. 13, the application kit 80 includes a body, shown as lift base 402, coupled to the chassis 20. The lift base 402 is coupled to a scissor assembly, shown as lift assembly 404, such that the lift base 402 supports the lift assembly 404. The lift assembly 404 is configured to extend and retract, raising and lowering between a raised position and a lowered position relative to the lift base 402.

As shown in FIG. 13, the lift base 402 includes a series of actuators, stabilizers, downriggers, or outriggers, shown as leveling actuators 410. The leveling actuators 410 may extend and retract vertically between a stored position and a deployed position. In the stored position, the leveling actuators 410 may be raised, such that the leveling actuators 410 do not contact the ground. Conversely, in the deployed position, the leveling actuators 410 may engage the ground to lift the lift base 402. The length of each of the leveling actuators 410 in their respective deployed positions may be varied in order to adjust the pitch (e.g., rotational position about a lateral axis) and the roll (e.g., rotational position about a longitudinal axis) of the lift base 402 and/or the chassis 20. Accordingly, the lengths of the leveling actuators 410 in their respective deployed positions may be adjusted to level the lift base 402 with respect to the direction of gravity (e.g., on uneven, sloped, pitted, etc. terrain). The leveling actuators 410 may lift the wheel and tire assemblies 54 off of the ground to prevent movement of the scissor lift 400 during operation. In other embodiments, the leveling actuators 410 are omitted.

The lift assembly 404 may include a series of subassemblies, shown as scissor layers 420, each including a pair of inner members and a pair of outer members pivotally coupled to one another. The scissor layers 420 may be stacked atop one another in order to form the lift assembly 404, such that movement of one scissor layer 420 causes a similar movement in all of the other scissor layers 420. The scissor layers 420 extend between and couple the lift base 402 and an operator platform (e.g., the platform assembly 431). In some embodiments, scissor layers 420 may be added to, or removed from, the lift assembly 404 in order to increase, or decrease, the fully extended height of the lift assembly 404.

Referring still to FIG. 13, the lift assembly 404 may also include one or more lift actuators 424 (e.g., hydraulic cylinders, pneumatic cylinders, electric linear actuators such as motor-driven leadscrews, etc.) configured to extend and retract the lift assembly 404. The lift actuators 424 may be pivotally coupled to inner members of various scissor layers 420, or otherwise arranged within the lift assembly 404.

A distal or upper end of the lift assembly 404 is coupled to an operator platform, shown as platform assembly 431. The platform assembly 431 may perform similar functions to the platform assembly 370, such as supporting one or more operators, accessories, and/or tools. The platform assembly 431 may include a control panel to control operation of the scissor lift 400. The lift actuators 424 may be configured to actuate the lift assembly 404 to selectively reposition the platform assembly 431 between a lowered position (e.g., where the platform assembly 431 is proximate to the lift base 402) and a raised position (e.g., where the platform assembly 431 is at an elevated height relative to the lift base 402). Specifically, in some embodiments, extension of the lift actuators 424 moves the platform assembly 431 upward (e.g., extending the lift assembly 404), and retraction of the lift actuators 424 moves the platform assembly 431 downward (e.g., retracting the lift assembly 404). In other embodiments, extension of the lift actuators 424 retracts the lift assembly 404, and retraction of the lift actuators 424 extends the lift assembly 404.

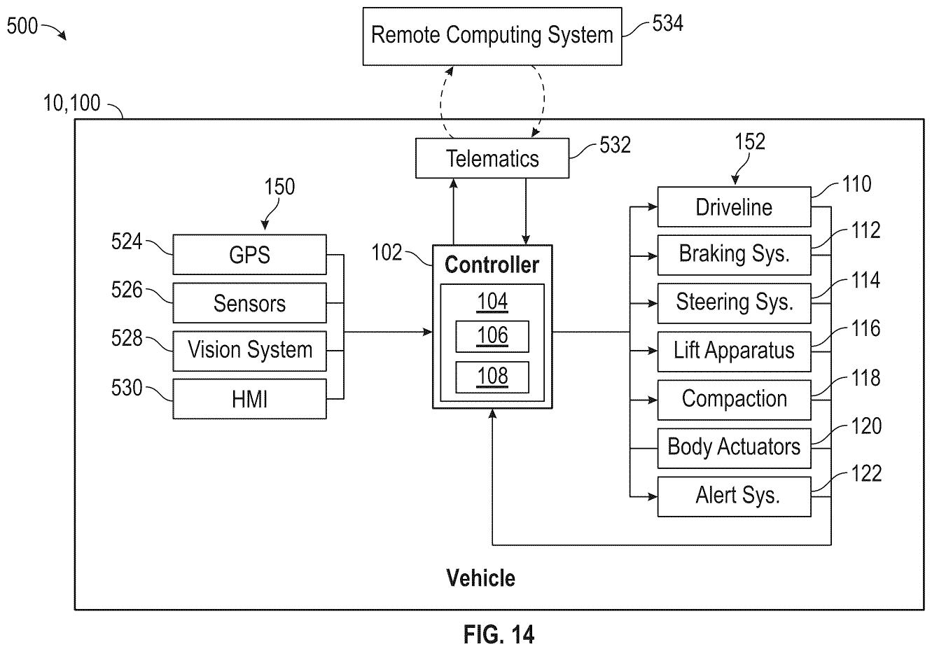

Referring to FIG. 14, the vehicle 10 (e.g., the refuse vehicle 100, the mixer truck 200, the fire fighting vehicle 250, the ARFF truck 300, the boom lift 350, the scissor lift 400) may include a control system 500 that is configured to facilitate autonomous or semi-autonomous operation of the vehicle 10, or components thereof. The control system 500 includes a controller 102 that is positioned on the vehicle 10, a remote computing system 534, a telematics unit 532, one or more input devices 150, and one or more controllable elements 152. The input devices 150 can include a Global Positioning System (“GPS”) 524, multiple sensors 526, a vision system 528 (e.g., an awareness system), and a Human Machine Interface (“HMI”) 530. The controllable elements 152 can include a driveline 110 of the refuse vehicle 100, a braking system 112 of the refuse vehicle 100, a steering system 114 of the refuse vehicle 100, a lift apparatus 116 (e.g., the lift assembly 140, the lift assembly 160, etc.), a compaction system 118 (e.g., a packer assembly, a packer within the compartment 130 and/or hopper volume 132, etc.), body actuators 120 (e.g., tailgate actuators 138, lift arm actuators 144, articulation actuators 148, finger actuators 168, lift actuator 172, track actuator 74, etc.), an alert system 122, and/or any other controllable components of the vehicle 10 and it various configurations described herein.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 524 (e.g., current latitude and longitude of the refuse vehicle 100). The controller 102 may receive sensor data (e.g., engine temperature, fuel levels, transmission control unit feedback, engine control unit feedback, speed of the refuse vehicle 100, etc.) from the sensors 526. The controller 102 may receive image data (e.g., real-time camera data) from the vision system 528 of an area (e.g., a field of view) of, near, or surrounding the refuse vehicle 100 (e.g., in front of the refuse vehicle 100, rearwards of the refuse vehicle 100, on a street-side or curb-side of the refuse vehicle 100, at the hopper of the refuse vehicle 100 to monitor refuse that is loaded, within the cab 40 of the refuse vehicle 100, and/or covering a 360 degree view around the refuse vehicle 100, etc.). The controller 102 may receive user inputs from the HMI 530 (e.g., button presses, requests to perform a lifting or loading operation, driving operations, steering operations, braking operations, user inputs via the user interface components of the cab interior 42, etc.).

The controller 102 may be configured to provide control outputs (e.g., control decisions, control signals, etc.) to the driveline 110 (e.g., an engine, a prime mover, a drive motor 62, an engine control unit, a transmission control unit, the chassis 20, tire assemblies 64, etc.) to operate the driveline 110 to transport the refuse vehicle 100. The controller 102 may also be configured to provide control outputs to the braking system 112 to activate and operate the braking system 112 to decelerate the refuse vehicle 100 (e.g., by activating a friction brake system, a regenerative braking system, etc.). The controller 102 may be configured to provide control outputs to the steering system 114 to operate the steering system 114 to rotate or turn at least two of the tractive elements to steer the refuse vehicle 100. The controller 102 may also be configured to operate actuators or motors of the lift apparatus 116 (e.g., tailgate actuators 138, lift arm actuators 144, articulation actuators 148, finger actuators 168, lift actuator 172, track actuator 74, etc.) to perform a lifting operation (e.g., to grasp, lift, empty, and return a refuse container, to open the tailgate 136, etc.). The controller 102 may also be configured to operate the compaction system 118 to compact or pack refuse that is within the refuse compartment 130. The controller 102 may also be configured to operate the body actuators 120 to implement a dumping operation of refuse from the refuse compartment 130 (e.g., driving the refuse compartment 130 to rotate to dump refuse at a landfill). The controller 102 may also be configured to operate the alert system 122 (e.g., lights, speakers, display screens, wearables, mobile devices, etc.) to provide one or more aural, haptic, or visual alerts to operators or nearby individuals.

The controller 102 may also be configured to receive feedback from any of the driveline 110, the braking system 112, the steering system 114, the lift apparatus 116, the compaction system 118, the body actuators 120, or the alert system 122. The controller 102 may provide any of the feedback to the remote computing system 534 via the telematics unit 532. The telematics unit 532 may include any wireless transceiver, cellular dongle, communications radios, antennas, etc., to establish wireless communication with the remote computing system 534. The telematics unit 532 may facilitate communications with telematics units 532 of nearby refuse vehicles 100 to thereby establish a mesh network of refuse vehicles 100.

The controller 102 is configured to use any of the inputs from any of the GPS 524, the sensors 526, the vision system 528, and/or the HMI 530 to generate controls for the driveline 110, the braking system 112, the steering system 114, the lift apparatus 116, the compaction system 118, the body actuators 120, and/or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 100 along a route (e.g., self-driving), autonomously alert users of hazards or nearby pedestrians/operators, perform pickups or refuse collection operations autonomously, and/or transport to a landfill to empty contents of the refuse compartment 130. The controller 102 may receive one or more inputs from the remote computing system 534 such as route data, indications of pickup locations along the route, route updates, customer information, pickup types, etc. The controller 102 may use the inputs from the remote computing system 534 to autonomously transport the refuse vehicle 100 along the route and/or to perform the various operations along the route (e.g., picking up and emptying refuse containers, providing alerts to operators/nearby individuals, limiting pickup operations until an individual has moved out of a predefined range/distance from a lift apparatus 116 or a hazard is avoided, etc.).

In some embodiments, the remote computing system 534 is configured to interact with (e.g., control, monitor, etc.) the refuse vehicle 100 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 534 may perform any of the route planning techniques as described in greater detail in U.S. application Ser. No. 18/111,137, filed Feb. 17, 2023, the entire disclosure of which is incorporated by reference herein. The remote computing system 534 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 100 and the remote computing system 534 may also operate or implement geofences as described in greater detail in U.S. application Ser. No. 17/232,855, filed Apr. 16, 2021, the entire disclosure of which is incorporated by reference herein.

### Refuse Detection for Waste and Recycle

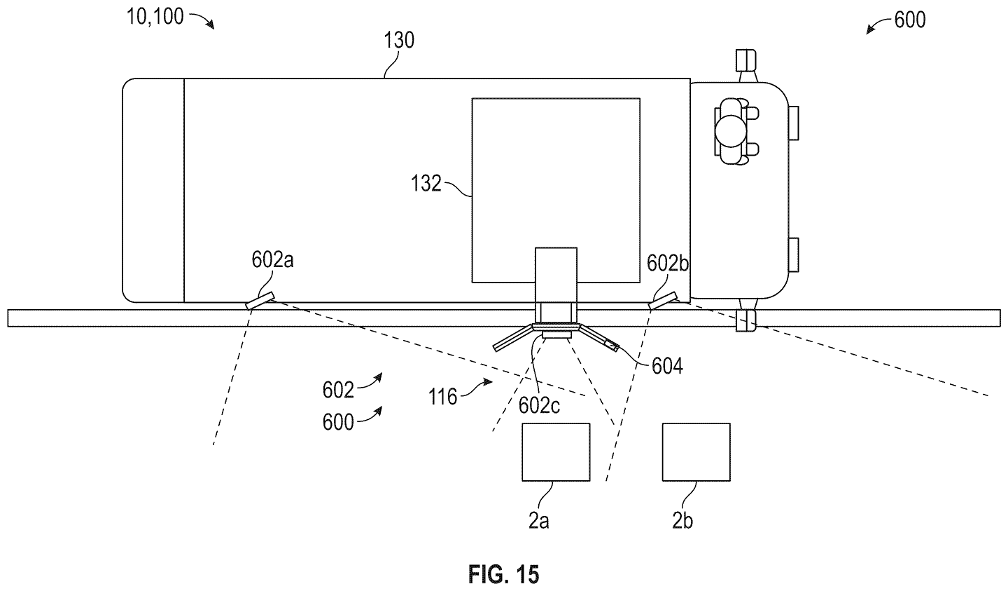

Turning to FIG. 15, a vehicle 10 (e.g., the refuse vehicle 100) is shown including an identification system 600 for detecting waste and recycling containers that is configured to identify a type of refuse container within a proximity of the refuse vehicle 100 (e.g., a refuse container 2a, a recycling container 2b, etc.). In some embodiments, the identification system 600 is incorporated into the control system 500. The identification system 600 may provide an indication of the type of refuse within a refuse container so that the appropriate type of refuse is emptied into a chamber or collected by a refuse vehicle that is configured to collect that type of refuse. The identification system 600 also facilitates collecting information regarding refuse and recycling pickup operations. For example, the refuse vehicle 100 may monitor whether a refuse container 2a or recycling container 2b is present at a pick-up location during a refuse collecting operation. Accordingly, data regarding which customers along a route place refuse containers 2a and/or recycling containers 2b in a collection zone may allow for improved route pathing (e.g., inform a shorter route for recycling-based refuse vehicles by allowing them to avoid locations that do not set out recycling containers 2b, etc.) and customer subscription management (e.g., allow for confirmation of whether a customer timely placed a refuse container 2a or a recycling container 2b at a pickup location).

As shown in FIG. 15, the identification system 600 may be provided on a side-loading refuse vehicle 100. In other embodiments, the identification system 600 may be implemented on a front-loading and/or rear-loading refuse vehicle 100. In FIG. 15, the refuse vehicle 100 includes the lift apparatus 116 on a curbside of the refuse vehicle 100. The lift apparatus 116 may include the grabber assembly 162 discussed above or another suitable lift apparatus 116 (e.g., a robotic arm having multiple articulable joints and a claw or grabber, a tracked lift apparatus including a grabber, or any combination thereof). The identification system 600 can include one or more cameras 602, shown as first camera 602a, second camera 602b, and third camera 602c. While the cameras 602 are shown disposed on a curb-side of the refuse vehicle 100, the cameras 602 may be positioned on a front of the refuse vehicle 100, a rear, on different corners, at different heights, at different orientations, on a street-side of the refuse vehicle 100, etc. More generally, the cameras 602 are directed outwards such that the containers 2 (e.g., the refuse container 2a, the recycling container 2b) are within a field of view of the cameras 602. The cameras 602 may obtain image data of the containers 2 as the refuse vehicle 100 arrives at and/or approaches the containers 2. As shown in FIG. 15, the third camera 602c may be disposed on a claw or portion of the lift apparatus 116. In this way, as the lift apparatus 116 approaches the refuse container 2, the third camera 602c may obtain higher resolution or close-up images of the refuse container 2.

The refuse vehicle 100 may be a multi-chambered vehicle including at least two refuse compartments, each for a different type of refuse, or may be a single-chambered vehicle including a single refuse compartment for one type of refuse. For example, the refuse vehicle 100 may be a garbage truck or a recycling truck with a single corresponding refuse compartment for garbage or recycling. The refuse vehicle 100 can also be a combination of a garbage truck and a recycling truck so that the refuse vehicle 100 can collect both garbage and recycling. If the refuse vehicle 100 is configured to collect both garbage and recycling (e.g., different types of refuse), the refuse vehicle 100 may include a hopper volume 132 having two hopper openings for the different types of refuse. The lift apparatus 116 may be configured to selectively transport and empty the refuse containers 2 into a respective hopper volume 132. In some embodiments, the hopper volume 132 has a partition that is transitionable between different positions or states in order to allow access to one of a first hopper opening or a second hopper opening, and to limit access to another of the first hopper opening or the second hopper opening. In this way, the lift apparatus 116 and the hopper volume 132 may be operated to empty refuse into one of a first refuse compartment or a second refuse compartment.

The identification system 600 may include additional sensors 526 and/or components of the vision system 528. For example, the identification system 600 may include a radio frequency identification (RFID) detector 604 (e.g., an RFID reader, an RFID transponder, etc.) that is configured to wirelessly transmit energy to proximate RFID tags. The RFID detector 604 may monitor responses that are received from nearby RFID tags. In particular, the refuse containers 2 may include RFID tags that are configured to provide a response signal to the RFID detector 604. The RFID detector 604 may be positioned on the lift apparatus 116 or on an exterior surface of the refuse vehicle 100 such that the RFID detector 604 is sufficiently close to the refuse containers 2 to communicate with RFID tags. The identification system 600 may also include QR code scanners, barcode scanners, etc. positioned on the lift apparatus 116 (e.g., on the grabber assembly 162) or on a side/top/corner/front/rear of the refuse vehicle 10.

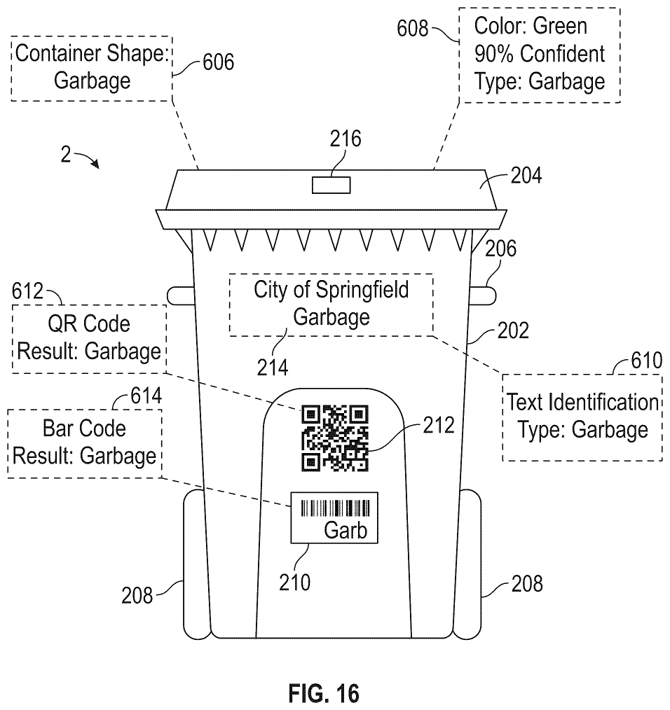

Turning to FIG. 16, a refuse container 2 can include a body 202 that defines a compartment or inner volume for refuse, a pair of wheels 208, handles 206, a lid 204, and printed text 214 or decals (e.g., a recycling symbol). The refuse container 2 may also include an RFID tag 216. The refuse container 2 may also include a quick response (QR) code 212. The refuse container 2 may also include a barcode 210. In some embodiments, one or more portions of the refuse container 2 have different colors to indicate whether the refuse container 2 contains garbage or recyclable materials.

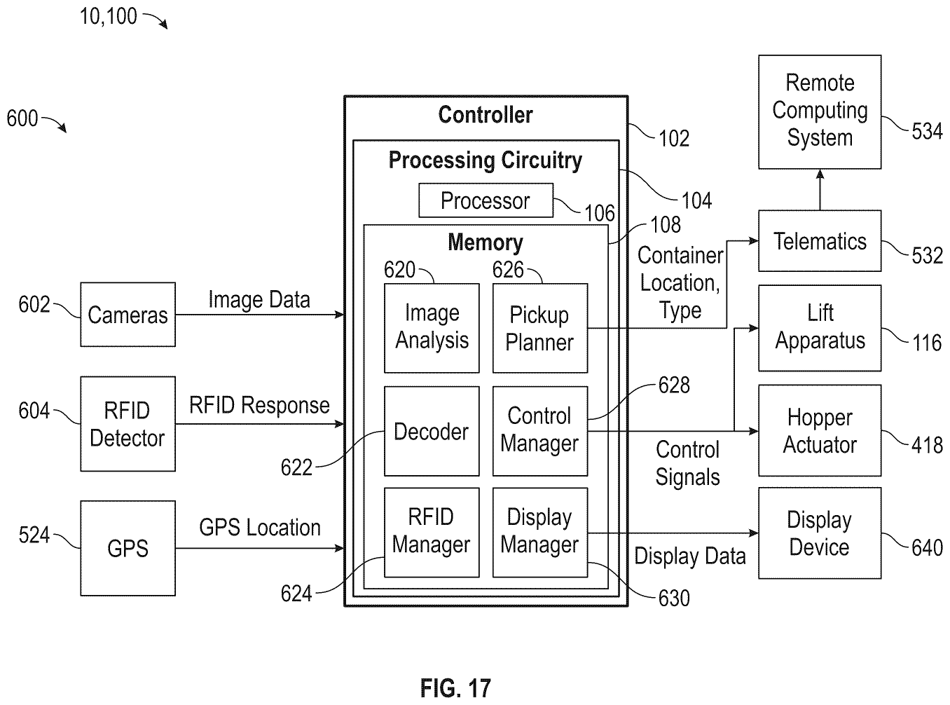

Turning to FIG. 17, the memory 108 of the controller 102 may include one or more items to facilitate operation of the identification system 600. For example, the memory 108 may include an image analysis circuit 620, a decoder 622, an RFID manager 624, a pickup planner 626, a control manager 628, and a display manager 630.

The image analysis circuit 620 may obtain the image data from the cameras 602 of the refuse containers 2 that are within the field of view of the cameras 602. The image analysis circuit 620 implemented by the processing circuitry 104 of the controller 102 is performed to identify a feature of the refuse container 2 to predict or identify a type of refuse that is within the refuse container 2 (e.g., whether the refuse container 2 is a recycling container 2b or a garbage container 2a). The image analysis circuit 620 may include identifying a color of the refuse container 2 or one or more portions of the container 2 (e.g., a color of the container lid 204, a color of the container body 202, etc.), and identifying, based on the detected color of the refuse container 2, the type of refuse that is within the refuse container 2. For example, in some municipalities, recycling containers 2b may a first predetermined color (e.g., blue) in color while garbage containers 2a may be a second predetermined color (e.g., green, gray, black, etc.) in color. The cameras 602 and the identification system 600 may use color sensing, colorimetry, or other processes or algorithms to receive image data of the refuse containers 2 and identify the color of the respective refuse containers 2. The color data may then be used to predict the type of refuse container 2 or the type of refuse in the container.

The image analysis circuit 620 may also be configured to predict the type of refuse container 2 based on a shape or size of the refuse container 2. For example, if standard refuse containers 2 are used with different sizes and shapes for recycling as opposed to garbage (e.g., round lid for recycling, angled lid for garbage, rounded corners for garbage, pointed corners for recycling, etc.), the image analysis circuit 620 can be implemented to identify, based on the size and shape, whether the refuse container 2 is a recycling container 2b or a garbage container 2a. The image analysis circuit 620 may use the size, shape, and position of features such as the body 202, one or more handles 206, the lid 204, one or more wheels 208, etc., alone or in combination with each other to determine the type of refuse container 2 in view of the cameras 602. In some embodiments, the one or more cameras 602 may use photogrammetry (e.g., acquiring 3D data from multiple 2D photographs via pixel matching, image overlaying, correlating the images based on known locations/distances) to discern a shape or size of the refuse container 2. In other embodiments, sensors 526 such as radar, LIDAR, and the like may determine the distance of refuse containers 2 from the cameras and provide distance information to the controller 102 to assist in determining the size and shape of the refuse containers 2 or features thereof.

The image analysis circuit 620 may also identify the text 214 or decal on the refuse container 2. For example, the text 214 on the refuse container 2 may indicate whether the refuse container 2 is a garbage can or a recycling can. The image analysis circuit 620 may perform an optical character recognition (OCR) technique and use a database of terms to identify, based on the text 214, whether the refuse container 2 is a recycling container 2b or a garbage container 2a (e.g., to predict the type of refuse that is within the refuse container 2). Additionally, the refuse container 2 may include a decal such as a recycling symbol, a decal associated with garbage containers (e.g., a municipal decal, a simple illustration of a figure tossing items into a bin, etc.). The image analysis circuit 620 may be configured to identify the decal and associate the decal with the corresponding type of refuse container 2 via a machine learning model, a look up table, an algorithm, or other suitable computer vision processes.

The image analysis circuit 620 may be configured to implement any machine learning, neural network, or artificial intelligence to identify whether the refuse container 2 is a garbage container 2a or a recycling container 2b (e.g., to predict a type of refuse within the refuse container 2). For example, the controller 102 may implement the image analysis circuit 620 by performing any of the functionality as described in greater detail in U.S. application Ser. No. 16/758,834, filed Apr. 23, 2020, the entire disclosure of which is incorporated by reference herein. The image analysis circuit 620 may be implemented locally on the controller 102 or remotely by the remote computing system 534. The controller 102, or more generally, the identification system 600, may also be configured to perform any of the functions or techniques to identify the type of refuse in the refuse container 2 or identify the type of refuse container 2 as described in greater detail in U.S. application Ser. No. 17/189,740, filed Mar. 2, 2021, the entire disclosure of which is incorporated by reference herein.

The decoder 622 can also be configured to obtain the image data from the cameras 602 and identify QR codes or bar codes in the image data of the refuse container 2. The decoder 622 may implement a QR code or barcode decoding technique based on the image data of the QR code 212 or the barcode 210 to determine results. The results may indicate a type of refuse container 2 that is present in the image data (e.g., a garbage container 2 or a recycling container 2).

The RFID manager 624 is configured to receive the RFID response from the RFID scanner 604 obtained from the RFID tag 216 of the refuse container 2. The RFID manager 624 may analyze the RFID response to determine, based on the RFID response, the type of refuse that should be present in the refuse container 2.

The image analysis circuit 620, the decoder 622, and the RFID manager 624 may be configured to determine, using the above-described functionality, a predicted type of refuse container 2 and provide the prediction to the pickup planner 626, the control manager 628, and the display manager 630. The pickup planner 626 may determine, based on the type of refuse container 2 and abilities of the refuse vehicle 100 (e.g., the type of refuse that the refuse vehicle 100 is capable of collecting, whether the refuse vehicle 100 has multiple refuse compartments 130, a fill level of refuse in the refuse compartments 130, etc.), if the refuse vehicle 100 is capable of emptying the refuse of the refuse container 2 into the hopper volume 132. If the refuse vehicle 100 is not capable of emptying the refuse of the refuse container 2, the pickup planner 626 may use the GPS location as the container location, and the type of refuse container 2 to schedule a pickup by a subsequent refuse vehicle 100 (e.g., the refuse vehicle 100 and/or the controller 102 may send a signal to a subsequent recycling truck identifying a recycling container 2b that requires pickup). The pickup planner 626 can provide the container location and the type of refuse container 2 to the remote computing system 534 for scheduled pickup at a later time via the telematics unit 532. Additionally, the pickup planner 626 may record, log, or otherwise store the container identification information in a database (e.g., on the memory 108, in the remote computing system 534) to maintain a historical or current record of the types of refuse containers 2 detected, the dates of detection/collection, and the location of their detection. In this way, the identification system 600 may track or identify which locations are associated with a type of refuse container 2 for route planning purposes. Further, the database may be utilized to verify pickup or customer drop-off of refuse containers (e.g., the identification system 600 may confirm whether a recycling container 2b and/or a refuse container 2a were detected at a specific location during a refuse pick-up operation).

The control manager 628 is configured to use the results of any of the image analysis circuit 620, the decoder 622, or the RFID manager 624 to operate at least one of the lift apparatus 116 or the articulation actuators 148 to empty the contents of the refuse container 2 into the hopper volume 132 of the refuse vehicle 100. For example, if the refuse vehicle 100 is a single compartment 130 refuse vehicle 100 that is configured to collect the type of refuse that is within the refuse container 2, the control manager 628 may provide control signals to the lift apparatus 116 to grasp, lift, and empty the refuse of the refuse container 2 into the hopper volume 132. Similarly, if the refuse vehicle 100 is a multi-compartment refuse vehicle, that control manager 628 may operate the lift apparatus 116 to empty contents of the refuse container 2 into the corresponding type of refuse compartment of the refuse vehicle 100 (e.g., the garbage compartment if a garbage container 2a is detected or the recycling compartment if a recycling container 2b is identified).

The display manager 630 may be configured to generate display data and operate a display 640 in the cab interior 42 or of the alert system 122 to provide the display data to an operator of the refuse vehicle 100 or a user that remotely controls or monitors the refuse vehicle 100. The display data may include various callouts overlaid or superimposed onto a real-world or digital image of the refuse container 2. The callouts may indicate the results of the image analysis circuit 620 and can include lines indicating the corresponding features. For example, as shown in FIG. 16, the display data may include a first callout 606 or visual indication that indicates the results of a container shape (e.g., container shape: garbage). The display data may also include a second callout 608 or visual indication that indicates the results of image analysis of particular features (e.g., color of a particular feature or component such as the lid 204, confidence of results, corresponding type). The display data may also include a third callout 610 that indicates the results of text identification (e.g., OCR of the detected text 214 of the refuse container 2, identification of a decal or symbol such as a recycling symbol on the refuse container 2, etc.). The display data may also include a fourth callout 612 that indicates the results of QR decoding (e.g., QR code result: garbage). The display data may also include a fifth callout 614 that indicates the results of barcode decoding (e.g., bar code result: garbage).

Additionally, the identification system 600 may be communicatively coupled to one or more wearables associated with an operator of the refuse vehicle 100 and/or a display of the in the cab interior 42 or of the alert system 122 to alert the operator when the refuse vehicle 100 is near/identifies a refuse container 2 of a given type. Wearables may include wristbands, necklaces, bracelets, key fobs, vests, seatbelt attachments, and the like that may use vibration, other haptic feedback, visual signals, audio signals, or a combination of the same to communicate or alert an operator of a condition detected by the identification system 600. For example, the refuse vehicle 100 may be a garbage truck and the identification system 600 may detect that the lift apparatus 116 is approaching/grabbing a recycling container 2b based on the size/shape/color etc. of the container 2 from the camera 602 data or the like. The identification system 600 may send a signal to the wearable or the display to inform the operator that a container 2 is of the incorrect type (e.g., by vibrating, by flashing red, by displaying text or an image of the recycling container 2b on a screen, etc.).

### Overhead Object Detection and Warning System

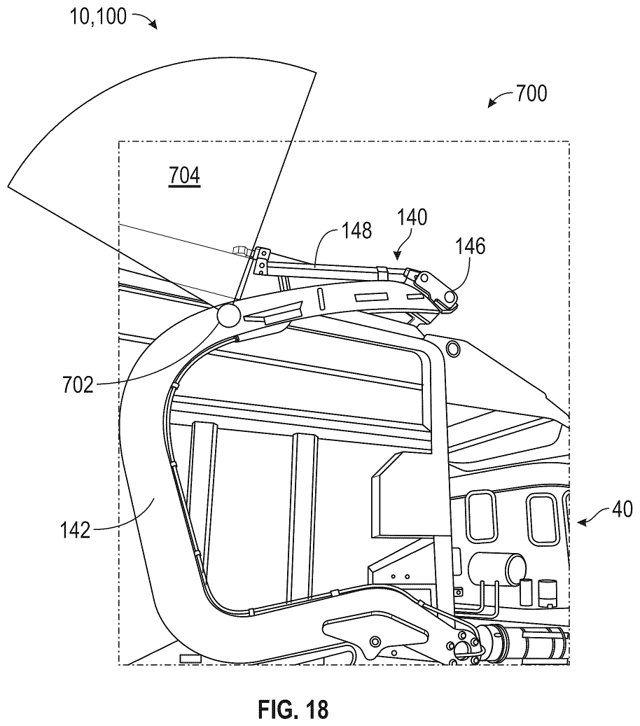

Turning to FIG. 18, a perspective view is shown of a vehicle 10 (e.g., the refuse vehicle 100) including an overhead object detection and warning (OODW) system 700. The OODW system 700 is configured to detect overhead objects, obstructions, and other hazards that may be in the path of a component of the refuse vehicle 100 during a refuse pick-up operation (e.g., lifting a refuse container and emptying the container into the hopper volume 132). In some embodiments, the OODW system 700 is incorporated into the control system 500. As shown in FIG. 18, the OODW system 700 is interoperable with a front-loading refuse vehicle 100 and may couple to a front lift assembly 140 and/or components thereof (e.g., lift arms 142, lift arm actuators 144, lift forks 146, articulation actuators 148, etc.). However, other embodiments are interoperable with rear loading refuse vehicles 100, side loading refuse vehicles 100, etc. and may be coupled to respective systems thereon such as side loading lift assemblies 160, tailgates 136, platform assemblies 431, and the like. The OODW system 700 may include one or more sensors 702 having one or more detection zones 704. The sensors 702 may be communicatively coupled to a controller 102 configured to perform and/or carry out functionalities of the OODW system 700 as discussed below. Additionally, the OODW system 700 may include one or more components of the refuse vehicle 100 coupled or communicatively coupled to the OODW system 700 (e.g., a display 640, the alert system 122, a wearable configured to alert an operator when the lift apparatus 116 is approaching a hazard, etc.).

As shown in FIG. 18, the refuse vehicle 100 includes the lift assembly 140. The lift assembly 140, in turn, may include lift arms 142, lift arm actuators 144, lift forks 146, articulation actuators 148, or other components thereof. One or more sensors 702 are coupled to the lift assembly 140 and/or the refuse vehicle 100. The one or more sensors 702 include a first sensor 702a mounted, affixed, or otherwise coupled to the refuse vehicle 100 such that the detection zone 704 of the first sensor 702a captures a region of interest at least partially above the refuse vehicle 100. Specifically, the detection zone 704 may comprise a region of interest ahead of the path that the lift assembly 140 and/or a refuse container gripped by the lift assembly 140 will follow during a refuse pick-up and/or collection operation (e.g., the detection zone 704 of the sensor 702a will include an area/region that the lift assembly 140 and/or the refuse container may move into at a future point in time compared to the time of data collection). In this way, the sensor 702a and the detection zone 704 are configured and positioned to detect and identify obstacles, hazards, or other objects in the path of the lift assembly 140, the refuse container, or other components of the refuse vehicle 100 during a refuse pick-up and/or collection operation to prevent collision between the refuse vehicle 100, components thereof, and the detected object/obstacle/hazard.

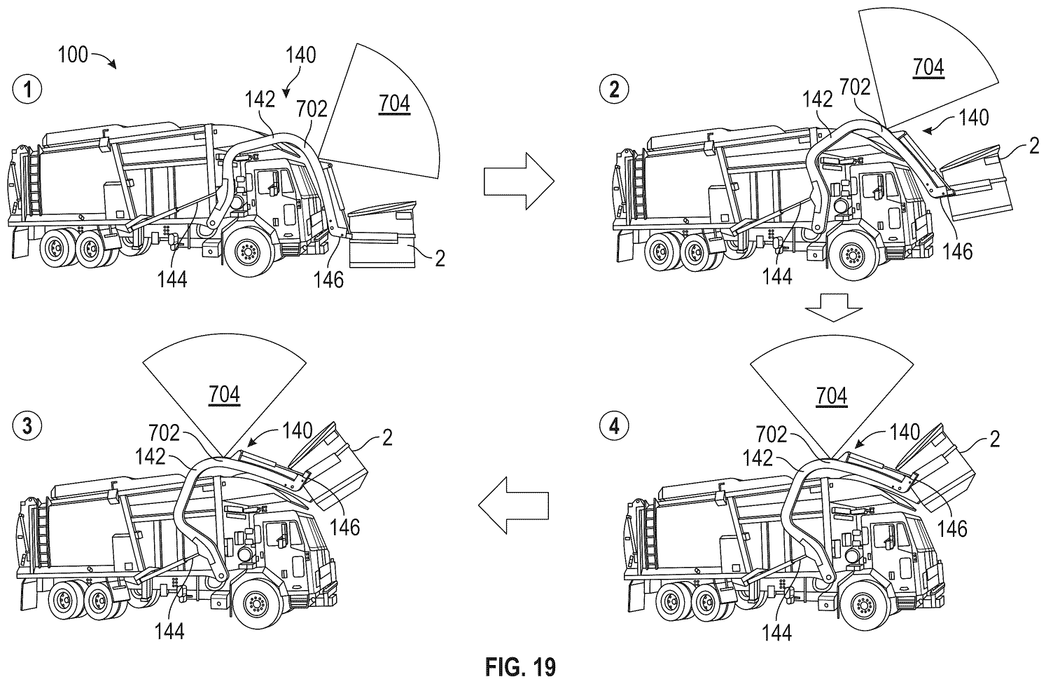

As shown in FIGS. 18 and 19, the OODW system 700 may be configured specifically to detect hazards, objects, and obstacles overhead and/or above the refuse vehicle 100. In preferred embodiments, the sensor 702a is coupled to the lift assembly 140 at the lift arm 142 proximate (e.g., within about 3 feet of, within about 2 feet of, affixed to an outward side of, etc.) the rearward anchor of the articulation actuators 148, as shown in FIG. 18. Beneficially, coupling the sensor 702 to the lift arm 142 may limit the exposure of the sensor 702 to corrosive materials (e.g., materials located in the refuse, in the hopper volume 132, that may drip or be proximate to the lift forks 146, etc.).

The sensors 702 may include one or more individual sensors 702, sensors 526 of the refuse vehicle 100, components of the vision system 528 and the like. For example, one or more of the sensors 702 may include cameras, ultrasonic sensors, proximity sensors, infrared sensors, radar, LIDAR, etc. coupled to an exterior of other portions of the refuse vehicle 100. The sensors 702 may be coupled to location on the refuse vehicle 100 suitable for capturing a region of interest ahead of the movement path of one or more lift apparatuses 116. In some embodiments, the sensors 702 include a camera in the form of a DSLR camera, a CCD camera, a time-of-flight camera, or any other equivalent camera capable of capturing an image of a target area. Further, the views from multiple sensors 702 (e.g., multiple cameras) may be combined, stitched together, placed adjacent to one another, or the like to achieve full coverage of the region of interest (e.g., a detection zone 704 in which the lift apparatus 116 may strike/collide with objects, individuals, buildings, power lines, tree branches, etc.).

The OODW system 700 may also include one or more components of the alert system 122 and/or HMI 530 such as a display 640 (e.g., a screen, monitor, or the like positioned within the cab 40, a remote display such a mobile device, a mobile phone, a wearable, etc.). The controller 102 and/or the OODW system 700 may communicate with and/or send signals to the display 640 to display images, video feed, or other sensor data from the sensors 702 (e.g., to an operator of the refuse vehicle 100). The OODW system 700 may display the sensor data to an operator via a display 640, may send a signal to components of the refuse vehicle 100 (e.g., cause an audible alarm to sound on the refuse vehicle 100, flash a light of the refuse vehicle 100, etc.) and/or may send a signal to a wearable (e.g., cause a wristband to vibrate, cause a vest to vibrate, cause a dashboard accessory/clip to light up and/or make a noise, etc.) in response to detecting a hazard, object, or the like within a certain distance of the lift assembly 140 or in the detection zone 704.

Turning to FIG. 19, a series of perspective views of the refuse vehicle 100 of FIG. 18 is shown, illustrating the change in the detection zone 704 of the sensor 702 as the lift assembly 140 operates (e.g., as a refuse pickup operation is performed). As shown in FIG. 19, when the lift assembly 140 is lowered and/or in a position to first engage with a refuse container 2 (top-right of FIG. 19), the sensor 702 may be coupled to the lift arm 142 such that the detection zone 704 is substantially forward and above the refuse vehicle 100. Further, the detection zone 704 may extend above the refuse container 2. In this way, before the refuse container 2 is lifted, the OODW system 700 may determine whether an obstacle or hazard is in the path of the refuse container 2 and/or the lift assembly 140. In some embodiments, the detection zone 704 extends in an arc approximately 2-5 feet above the refuse container 2, having a radius of approximately 10-20 feet and an angle of approximately 60-110 degrees.

As the lift assembly 140 lifts the refuse container 2 towards the hopper volume 132 and upwards off the ground, the detection zone 704 of the sensor 702 remains ahead of the lift assembly 140 and the refuse container 2. In this way, before the lift assembly 140 and/or the refuse container 2 potentially intersect with an overhead object, the OODW system 700 may send a signal indicative of an object to alert the operator and/or automatically cease, pause, slow down, or otherwise inhibit the refuse pick-up and collection operation until the path of the lift assembly 140 and the refuse container 2 are clear of obstructions. In some embodiments, the OODW system 700 may be configured to detect a hazard/obstacle/obstruction, determine its location relative to the refuse vehicle 100, determine a steering and/or repositioning operation to position the refuse vehicle 100 in a location clear of the detected hazard/obstacle/obstruction, and cause the refuse vehicle 100 to perform the steering/and or repositioning operation before resuming the refuse pick-up and collection operation.

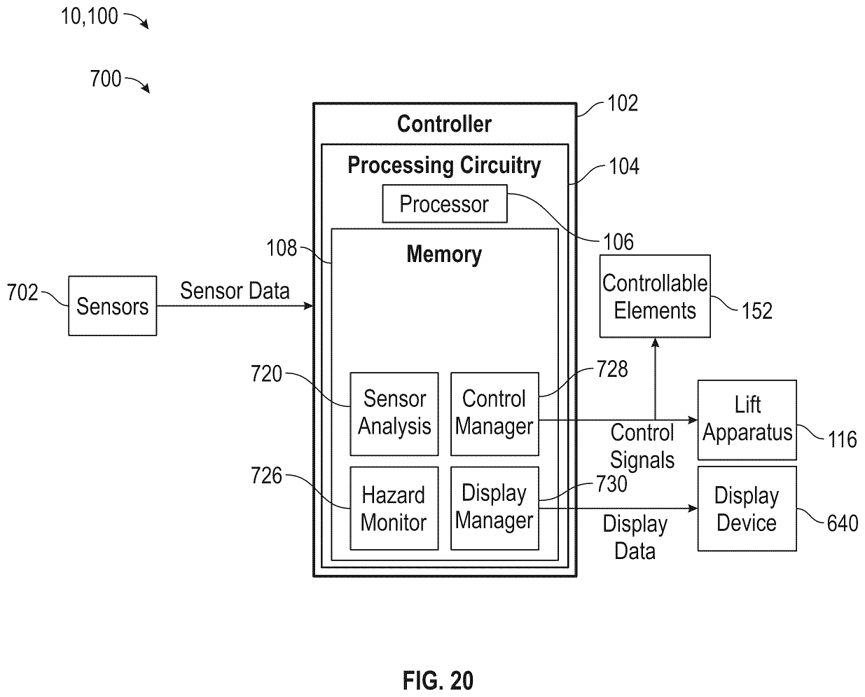

Turning to FIG. 20, the memory 108 of the controller 102 may include one or more items to facilitate operation of the OODW system 700. For example, the memory 108 may include a sensor analysis circuit 720, a hazard monitor circuit 726, a control manager 728, and a display manager 730.

The sensor analysis circuit 720 may obtain the sensor data from the sensors 702. For example, the sensor analysis circuit 720 may use radar, LIDAR, or the like to determine the proximity of an object or hazard to the sensor 702 or whether an item is within a certain region/distance of the detection zone 704. The sensor analysis circuit 720 implemented by the processing circuitry 104 of the controller 102 is performed to identify whether an obstruction, hazard, or object is located along the path of the lift assembly 140 and/or the refuse vehicle 100 (e.g., whether the refuse container 2 will potentially collide with an object if the refuse collection operation continues/begins, whether the lift arms 142 are free to raise uninhibited, etc.). The sensor analysis circuit 720 may be configured to identify an object within the detection zone based on a color, shape, or size of the object. For example, the sensor analysis circuit 720 can be implemented to identify an overhead power line within the path of the lift apparatus, based on the size, shape, and distance of the line from the sensor 702. In other embodiments, sensors 702 may detect electric and/or magnetic fields to identify obstructions such as powerlines, transformers, and the like. In other embodiments, sensors 526 such as cameras, radar, LIDAR, and the like may determine the presence of a tree branch within the detection zone 704 based on a color detected in the image data, an area/profile of the image occupied by the object, and/or movement of the object within the detection zone 704.

The sensor analysis circuit 720 may be configured to implement any machine learning, neural network, or artificial intelligence to identify whether the detection zone 704 is obstructed and may determine a percentage of certainty regarding a potential collision between the lift assembly 140 and/or the refuse container 2 and an overhead object. The operations of the sensor analysis circuit 720 may be implemented locally on the controller 102 or remotely by the remote computing system 534.

Once the sensor analysis circuit 720 has identified an object, obstacle, or obstruction, the hazard monitor circuit 726 may be configured to flag, log, track, or otherwise continue to identify the location of the hazard relative to the refuse vehicle 100, the lift assembly 140, etc. For example, the hazard monitor circuit 726 may receive signals from an angle sensor or rotary encoder configured to measure an angle of the lift arms 142. The hazard monitor circuit 726 may associate the angle with a position and/or location of the lift arms 142 and may compare the location with the sensor data received from the sensors 702. Further, the hazard monitor circuit 726 may determine a pathing, a lift apparatus 116, a steering and/or breaking operation that will distance the refuse vehicle 100 and the components thereof from the detected hazard/obstacle.

The sensor analysis circuit 720 and the hazard monitor circuit 726 may be configured to determine, using the above-described functionality, a location of a hazard relative to the refuse vehicle 100 and provide the location of the hazard as well as the location of unobstructed regions to the control manager 728 and the display manager 730.

The control manager 728 is configured to use the results of the sensor analysis circuit 720 and the hazard monitor circuit 726 to operate at least one component of the refuse vehicle 100. For example, in an autonomous or semi-autonomous operation mode, the control manager 728 may send a signal to the lift apparatus 116 to stop raising and/or to lower the refuse container 2 to avoid the obstruction identified by the OODW system 700. For example, if the refuse vehicle 100 is beneath a banner extending across a roadway, the sensors 702 may detect the size, shape, color, etc. of the banner in the detection zone 704. The sensor analysis circuit 720 may determine a distance, proximity, location of the banner, and the hazard monitor circuit 726 may determine that reversing the refuse vehicle 100 by a predetermined distance will remove the banner from the path of the lift apparatus 116 (e.g., may place the banner outside of a predefined distance from the sensor 702). The control manager 728 may provide control signals to the lift apparatus 116 to lower and/or stop lifting the refuse container 2. Similarly, the control manager 728 may operate or cause operation of one or more controllable elements 152 of the refuse vehicle 100 (e.g., the driveline 110, the steering system 114, the braking system 112) to autonomously or semi-autonomously cause the refuse vehicle 100 to navigate away from the hazard (e.g., the banner) and continue the refuse pick-up and collection operation.

The display manager 730 may be configured to generate display data and operate a display 640 in the cab interior 42 or of the alert system 122 to provide the display data to an operator of the refuse vehicle 100 or a user that remotely controls or monitors the refuse vehicle 100. The display data may include images, video feed, or the like of the detection zone 702, a perspective view from a camera allowing the operator to view the path of the lift assembly 140, a view from one or more cameras mounted to the top of the refuse vehicle 100 providing a panoramic, stitched image, or 360-degree view of the surroundings of the refuse vehicle 100. Additionally, the OODW system 700 may provide various callouts overlaid or superimposed onto a real-world or digital image of the detection zone 704. The callouts may include an outline of the obstacle/hazard, text identifying the hazard, a callout indicating a calculated distance/proximity of the obstacle from one or more components of the refuse vehicle 100 (e.g., distance from refuse container 2, distance from lift arm 142, etc.).

Additionally, the OODW system 700 may be communicatively coupled to one or more wearables associated with an operator of the refuse vehicle 100 and/or a display of the in the cab interior 42 or of the alert system 122 to alert the operator when an obstacle is detected within the path (e.g., the detection zone 704) of the refuse vehicle 100, the lift apparatus 116, and/or the refuse container 2. For example, the refuse vehicle 100 may be a garbage truck and the OODW system 700 may detect that the lift apparatus 116 is approaching a roof overhang based on the size/shape/color/proximity etc. of the obstruction received from the camera 702 data or the like. The OODW system 700 may send a signal to the wearable or the display to inform the operator that the lift apparatus 116 has potential to collide with an obstacle if the refuse pick-up and collection operation continues (e.g., by vibrating, by flashing red, by displaying a warning text/image on a screen and sounding an alarm, etc.).

Hopper Contaminant and/or Thermal Monitoring System

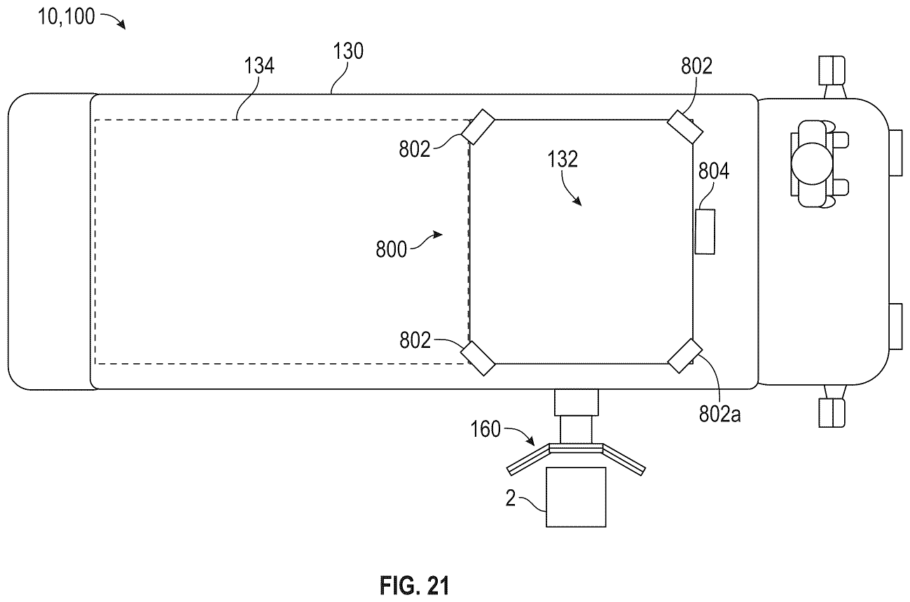

Turning to FIG. 21, a top perspective view is shown of a refuse vehicle 100 equipped with a hopper system 800. The hopper system 800 is configured to detect monitor the hopper volume 132 and/or the storage volume 134. For example, the hopper system 800 may detect contaminates (e.g., items, objects, debris, etc. that are not intended to be collected by a refuse vehicle 100, that are hazardous, that are placed in the incorrect refuse container 2, etc.) in the refuse stream by analyzing the contents of a refuse container 2 as it is emptied into the hopper volume 132. The hopper system 800 may also include one or more thermal sensors and/or fire mitigation devices to detect a spark, excessive heat, smoke, or fire in the hopper volume 132 and/or the storage volume 134. The fire mitigation devices may be configured to activate in response to a sensor detecting a temperature threshold or in response to a signal indicating the presence of smoke or fire in the hopper volume 132 and/or storage volume 134. Activation of the fire mitigation device may prevent/eliminate a potential fire hazard or douse a fire present in the hopper volume 132 and/or the storage volume 134.

As shown in FIG. 21, the hopper system 800 is arranged on a side-loading refuse vehicle 100 and may couple to a top side of the refuse vehicle 100, the walls of the hopper volume 132, or the like. In other embodiments, the hopper system 800 may be arranged on a rear loading refuse vehicles 100, front loading refuse vehicles 100, etc. and the components of the hopper system 800 (e.g., sensors 802 and fire mitigation device 804) may be coupled to respective systems thereon such as front-loading lift assemblies 140, tailgates 136, platform assemblies 431, and the like.

The hopper system 800 may include one or more sensors 802 configured to identify contaminants in the refuse stream and/or to detect a condition of the hopper volume 132. The sensors 802 may be communicatively coupled to a controller 102 configured to perform and/or carry out functionalities of the hopper system 800. Additionally, the hopper system 800 may include one or more components of the refuse vehicle 100 coupled or communicatively coupled to the hopper system 800 (e.g., a display 640, the alert system 122, a wearable configured to alert an operator when a fire hazard or fire is detected in the hopper volume 132, etc.). In this disclosure, the term “fire hazard” may mean any circumstance or object that has potential to cause combustion of material within the hopper volume 132 and/or storage volume 134. For example, a fire hazard may include the presence of smoke, an item in the hopper volume reaching a threshold temperature (e.g., above 200 degrees Fahrenheit), sparks present in the hopper, flames or material igniting, or the like.

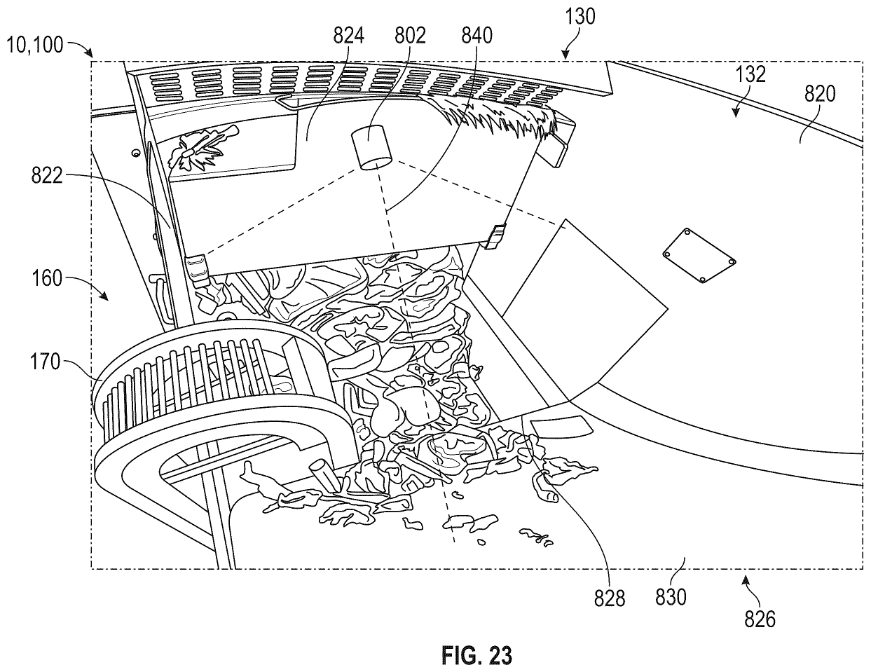

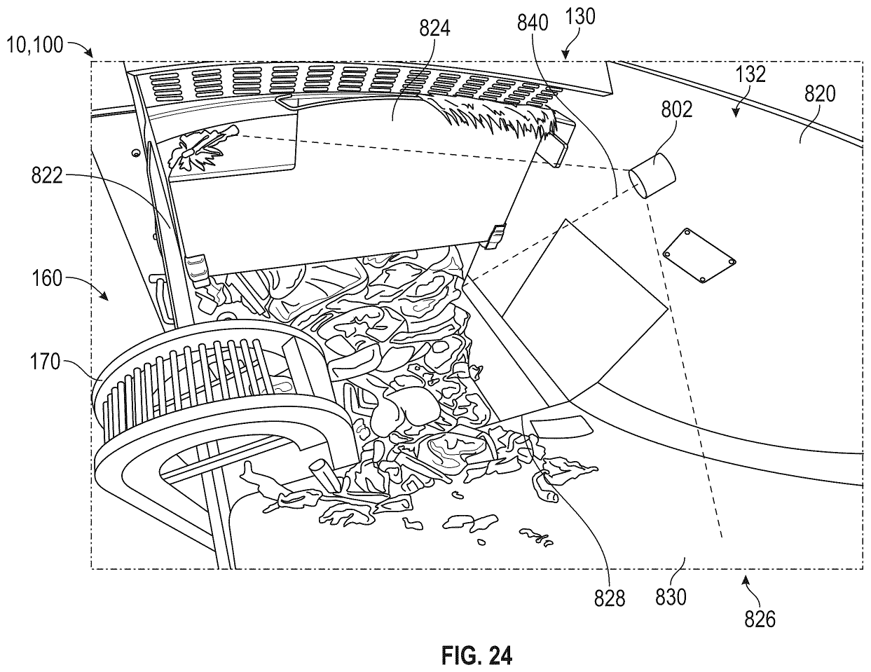

As shown in FIG. 21, the sensors 802 may be mounted around the corners of the hopper volume 132 or otherwise positioned to achieve a full or partial view of the hopper. The sensors 802 may include cameras, proximity detectors, ionization/photoelectric smoke detectors, thermal imaging cameras, ultraviolet/infrared flame detectors, thermometers (e.g., infrared thermometers), spark detectors, etc. coupled to an exterior portion of the refuse vehicle 100. In some embodiments, one or more of the sensors 802 may be coupled to location inside the hopper volume 132, as shown in FIGS. 23 and 24. In some embodiments, the sensors 802 include a camera in the form of a DSLR camera, a CCD camera, a time-of-flight camera, or any other equivalent camera capable of capturing an image refuse as it enters the hopper volume 132. Further, the views from multiple sensors 802 (e.g., multiple cameras 802) may be combined, stitched together, placed adjacent to one another, or the like to achieve full coverage of the hopper volume 132. As shown in FIG. 21, at least one sensor 802a may include a thermal imaging camera 802a configured to capture thermal image data of the inside of the hopper volume 132. While the thermal imaging camera 802a is shown placed in a top corner of the hopper volume 132, in other embodiments, the at least one thermal imaging camera 802a may be located at any other suitable location(s).

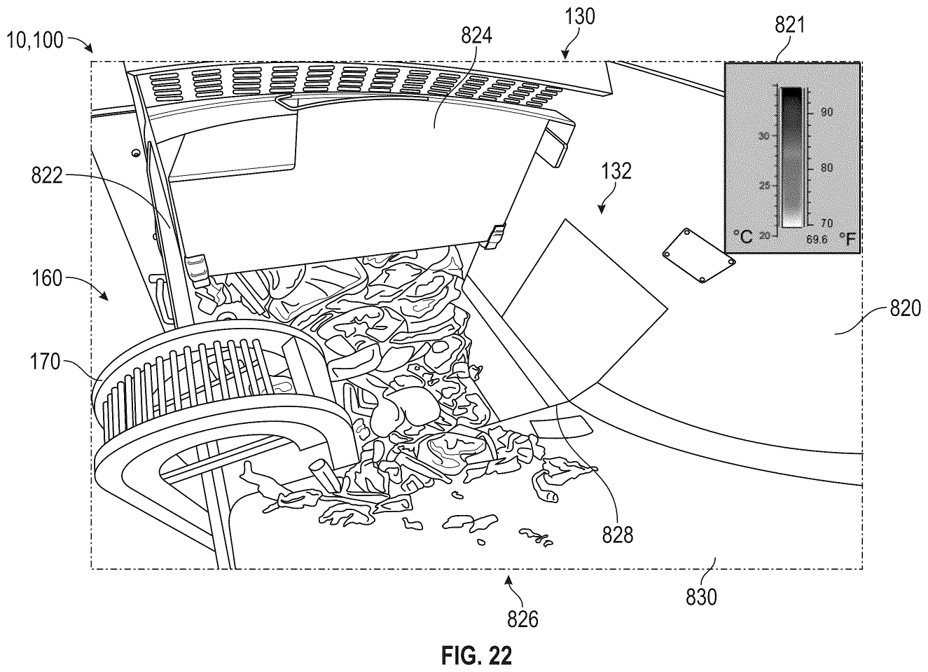

The hopper system 800 may also include one or more components of the alert system 122 and/or HMI 530 such as a display 640 (e.g., a screen, monitor, or the like positioned within the cab 40, a remote display such a mobile device, a mobile phone, a wearable, etc.). The controller 102 and/or the hopper system 800 may communicate with and/or send signals to the display 640 to display images, video feed, or other sensor data from the sensors 802 (e.g., to an operator of the refuse vehicle 100). The hopper system 800 may display the sensor data to an operator via a display 640, may send a signal to components of the refuse vehicle 100 (e.g., cause an audible alarm to sound on the refuse vehicle 100, flash a light of the refuse vehicle 100, etc.) and/or may send a signal to a wearable (e.g., cause a wristband to vibrate, cause a vest to vibrate, cause a dashboard accessory/clip to light up and make a noise, etc.) in response to detecting a fire hazard, fire, or contaminant in the hopper volume 132. For example, as shown in FIGS. 22-24, image data and/or sensor data providing a view of the hopper volume 132 may be presented on a display 640. The image data may include a video feed, a video feed including thermal imaging/overlay of various temperatures in the hopper volume 132, etc.

FIGS. 22-24 illustrate an exemplary embodiment of the hopper volume 132 of a side-loading refuse vehicle 100 equipped with a hopper system 800. FIG. 22 illustrates the hopper volume 132 as viewed from the thermal imaging camera 802a. As shown in FIG. 22, the display 640 may include a video feed from the thermal imaging camera 802a showing the inside of the hopper volume 132 and the temperatures therein (e.g., based on a color correlated temperature scale 821). The hopper volume 132 of the refuse compartment 130 may be defined by a left sidewall 820, a right sidewall 822, a holding plate 824, and a packing assembly 826. The packing assembly 826 includes a pack panel 828 and a pivot plate 830. The left sidewall 820 extends longitudinally (e.g., in a direction extending between the cab 40 and the tailgate 136) between the holding plate 824 and the packing assembly 826. The lift assembly 160 is arranged on the right sidewall 822, and the holding plate 824 extends downwardly (e.g., in a direction toward the chassis 20, or in a direction perpendicular to the ground on which the refuse vehicle 100 travels) from a top wall of the refuse compartment 130. In general, the holding plate 824 separates the hopper volume 132 and the storage volume 134 and forms a partition between the two sections in the refuse compartment 130. In addition, the holding plate 824 aids in preventing refuse being packed into the storage volume 134 from falling back toward the hopper volume 132. The thermal imaging camera 802a may detect the temperatures inside the hopper volume 132 and send a signal to alert an operator upon detecting a temperature higher than a threshold temperature.

Turning to FIGS. 23-24, the hopper system 800 may include a sensor 802 coupled to a portion of the refuse compartment 130. The hopper sensor 802 is arranged so that a field of view 840 is directed toward the hopper volume 132, which enables the hopper sensor 802 to identify, detect, or otherwise receive data indicative of contaminants and/or fire hazards within the hopper volume 132. In some embodiments, the hopper sensor 802 is configured to detect a contaminant in the refuse stream. Contaminants may include any item, object, or material that should not be placed within the refuse vehicle 100 or that should be placed in a different refuse vehicle 100. For example, contaminants for a refuse truck may include recycling articles, certain electronics, oxygen tanks, medical infectious waste, heavy metals, harmful chemicals such as caustic substances, flammable oils, tires, certain light bulbs, batteries, paint, aerosol cans, construction debris, and the like. Contaminants for a recycling truck may include non-recyclable materials and the materials discussed above. Sensors 802 within the hopper volume 132 to detect and identify contaminants may include those of the form discussed above, as well as pH sensors, biological sensors, cameras, etc. that utilize corresponding algorithms (e.g., machine learning algorithms) configured to identify objects as they enter the hopper volume 132. In some embodiments, the hopper sensor 802 is coupled to the holding plate 824, as shown in FIG. 23. In some embodiments, the hopper sensor 802 is coupled to the left sidewall 820, as shown in FIG. 24. In some embodiments, the hopper sensor 802 is coupled to any internal surface or sidewall of the refuse compartment 130 so that the hopper sensor 802 is arranged to direct the field of view 840 toward the hopper volume 132 and the refuse therein. Additionally, in some embodiments, the views of one or more sensors 802 inside and/or outside the hopper may be combined, analyzed separately, stitched together, or the like to provide a full view of the refuse stream entering the hopper volume 132.

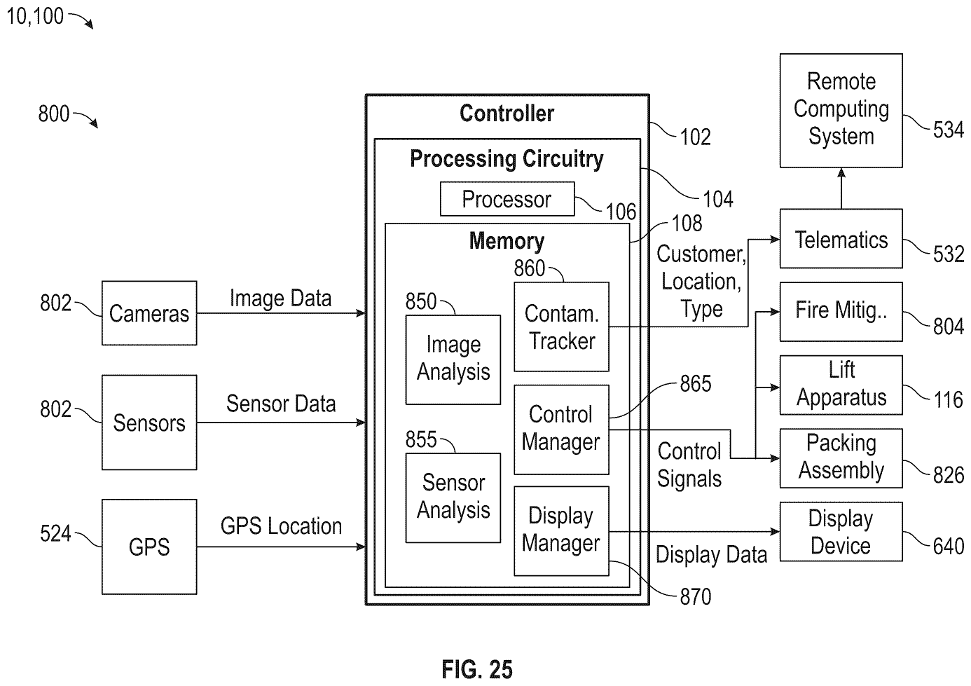

Turning to FIG. 25, the memory 108 of the controller 102 may include one or more items to facilitate operation of the hopper system 800. For example, the memory 108 may include an image analysis circuit 850, sensor analysis circuit 855, a contamination tracker 860, a control manager 865, and a display manager 870.

The image analysis circuit 850 may obtain the image data from the cameras 802, similar to the image analysis circuit 620, discussed above. The image analysis circuit 850 may be utilized by the processing circuitry 104 of the controller 102 to identify a contaminant or a feature of a contaminant in the hopper volume 132. For example, the image analysis circuit 850 may be configured to identify a contaminant within the detection zone based on a color, shape, or size of the object as compared to known contaminants or predefined restricted items (e.g., stored in a list, a lookup table, etc.). For example, the image analysis circuit 850 may identify a tire in the hopper volume 132 based on the size (e.g., approximately 33 inches across), shape (round), color (black), texture (presence of grooves/treads), etc. The image analysis circuit 850 may be configured to implement any machine learning, neural network, or artificial intelligence to identify whether a contaminant is located within the hopper volume 132 and/or the field of view 840 of a sensor 802. Similarly, the image analysis circuit may detect a fire hazard within the hopper volume 132 by identifying smoke, sparks, flames, a certain heat-level depicted on a thermal camera, etc.

The sensor analysis circuit 855 may obtain the sensor data from the sensors 802. For example, the sensor analysis circuit 855 may receive data from ionization/photoelectric smoke detectors, ultraviolet/infrared flame detectors, thermometers (e.g., infrared thermometers), spark detectors, pH detectors, etc. to determine whether a contaminant or fire hazard is present in the refuse stream similar to the image analysis circuit 850. For example, an infrared thermometer reading above a temperature threshold may indicate a fire hazard in the hopper volume 132 and trigger the fire mitigation device 804 to activate (e.g., douse the hopper volume 132 with a fire retardant, cover the hopper volume 132 in a fire blanket, etc.). The operations of the image analysis circuit 850 and/or the sensor analysis circuit 855 may be implemented locally on the controller 102 or remotely by the remote computing system 534.

Once the image analysis circuit 850 and/or the sensor analysis circuit 855 have identified a contaminant, the contamination tracker 860 may be configured to flag, log, track, or otherwise identify the contaminant and associate the contaminant with the location, customer, or route along which the contaminant was collected. In this way, the hopper system 800 may identify customers or individuals who dispose of prohibited items/contaminants. Data associated with the customer, location, GPS location of pickup, and the like may be communicated to the telematics unit 532 and/or stored on the remote computing system 534, which may generate or send a signal directing the refuse vehicle 100 to an appropriate facility or location to dispose of the contaminated refuse.

In response to the image analysis circuit 850 and/or the sensor analysis circuit 855 detecting a fire hazard, the control manager 865 may send a signal one or more components of the refuse vehicle 100 to autonomously or semi-autonomously mitigate the fire hazard or douse a fire in the hopper volume 132. For example, the control manager 865 may cause the packing assembly 826 to deactivate or stop movement of the pack panel 828. Additionally, the control manager 865 may cause the lift apparatus 116 to cease emptying refuse into the hopper volume 132, to close the hopper volume 132 to prevent additional oxygen reaching the fire, etc. Further, the control manager 865 may cause the fire mitigation device 804 to operate to douse or prevent a fire. For example, the fire mitigation device may include a water tank, a chemical fire-retardant sprayer, a non-flammable gas dispenser, or the like. Upon activation, the fire mitigation device may spray a fire-retardant foam into the hopper, douse the contents of the hopper in water or a non-flammable fluid, release a fire blanket over the hopper, etc.

The display manager 870 may be configured to generate display data and operate a display 640 in the cab interior 42 or of the alert system 122 to provide the display data to an operator of the refuse vehicle 100 or a user that remotely controls or monitors the refuse vehicle 100. The display data may include images, video feed, or the like from the sensors/cameras 802, a perspective view from a camera allowing the operator to view into the hopper volume 132, etc. Additionally, the hopper system 800 may provide various callouts overlaid or superimposed onto a real-world or digital image of the hopper volume 132. The callouts may include an outline of the contaminant, text identifying the contaminant, a callout indicating a percentage certainty of the contaminant identity, percentage certainty of a fire hazard, etc.

Additionally, the hopper system 800 may be communicatively coupled to one or more wearables associated with an operator of the refuse vehicle 100 and/or a display of the in the cab interior 42 or of the alert system 122 to alert the operator when a contaminant or fire hazard is detected (e.g., in the hopper volume 132). For example, the refuse vehicle 100 may be a garbage truck and the hopper system 800 may detect that a tire has entered the hopper volume 132 based on the size/shape/color/weight etc. of the item received from the camera 802, measured from a sensor 802 on the lift apparatus or in the hopper volume 132, etc. The hopper system 800 may send a signal to the wearable or the display to inform the operator that a contaminant (e.g., a tire, an oxygen tank, etc.) has been placed into the hopper volume 132 and send a signal, text, or other indication (e.g., by vibrating, by flashing red, by displaying a warning text/image on a screen and sounding an alarm, etc.) to stop or pause a compaction or refuse collection operation or to activate the fire mitigation device.

### Detection and Warning System

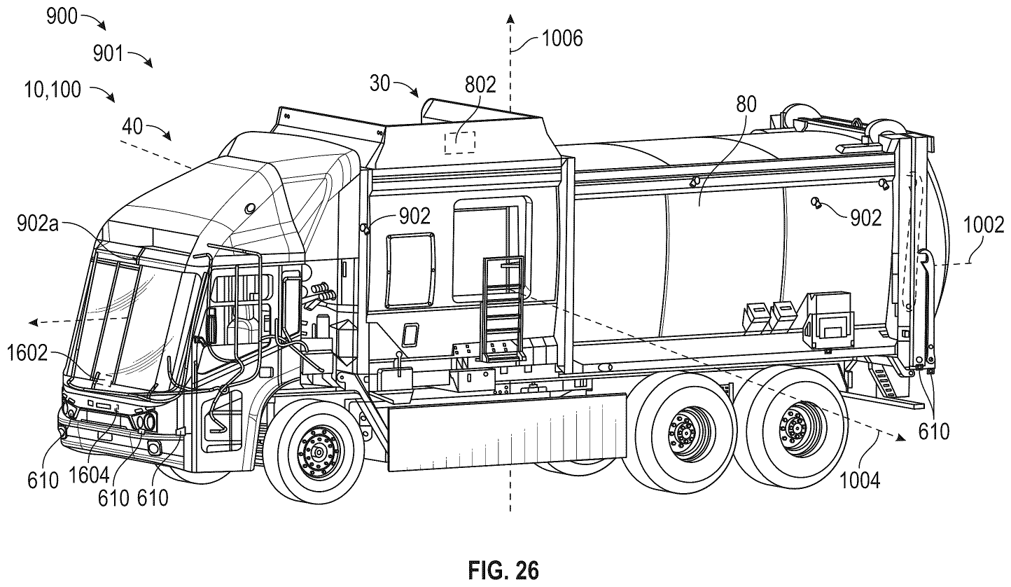

Turning to FIG. 26, a perspective view is shown of the vehicle 10 (e.g., the refuse vehicle 100) including a 360 Degree Detection and Warning System (e.g., an Advanced Driver Assistance System) (ADAS) 900. The ADAS 900 may be interoperable with side-loading refuse vehicles 100, rear loading refuse vehicles 100, front loading refuse vehicles 100, mixer trucks 200, fire fighting vehicles 250, etc. like the other systems discussed above. The ADAS 900 is configured to detect and monitor an area around the perimeter of the vehicle (e.g., the refuse vehicle 100). For example, the ADAS 900 may detect individuals (e.g., a second operator, civilians, etc.) within a designated proximity of the refuse vehicle 100 and provide a warning to the operator regarding the location of the individual with respect to the refuse vehicle 100. For example, the ADAS 900 may be configured to collect data from multiple sensors (e.g., cameras) and generate a 360-degree view to detect the presence of anyone who approaches within 4 feet, 6 feet, 8 feet, and the like of the refuse vehicle 100 and notify the operator. The ADAS 900 may stitch together multiple camera views, may use photogrammetry, pixel matching, or any other suitable process for combining the data of multiple sensors/cameras into a 360-degree view (e.g., a top-down or “bird's eye” view, a panoramic view, etc.) around the refuse vehicle 100.

In some embodiments, the ADAS 900 may be configured to detect and warn an operator of an object approaching at a high velocity. Notably, when parked and collecting refuse, the refuse vehicle 100 is at risk of being struck (e.g., from behind, from on-coming traffic, etc.) by pedestrian or municipal vehicles. The ADAS 900 may implement long range and short-range sensors (e.g., radar, LIDAR, velocity detectors, proximity detectors, etc.) to detect the presence of an object above a threshold size approaching the refuse vehicle 100 above a threshold velocity. Upon detecting the high velocity (e.g., 20 mph, 30 mph, 40 mph, 50 mph, etc.) object, the ADAS 900 may signal the operator based on the speed, size, and proximity of the object to proactively warn the operator of a possible collision and provide time for the operator to take mitigating action (e.g., buckle a seatbelt, avoid exiting from the street-side of the refuse vehicle 100, etc.). Specifically, the ADAS 900 may provide the warning signal via a display 640, one or more components of the refuse vehicle 100, and/or via wearables worn or equipped by the operator.

In still further embodiments, the ADAS 900 may be configured to monitor and alert a first operator (e.g., an operator in the cab 40) of the location of a second operator (e.g., an operator handling refuse containers 2 at a curb or adjacent to the refuse vehicle 100). The ADAS 900 may continuously monitor and/or track the location of the second operator and send a signal indicative of the position of the second operator relative to the refuse vehicle 100 to a display such as the display 640, a display in the cab 40, the screen of a mobile device, etc. In this way, the ADAS 900 may inform the first operator of the location of the second operator or notify the first operator of hazards near the second operator. For example, in response to detecting a control signal sent to the lift apparatus 116, the ADAS 900 may cause a display or a wearable of the first operator to indicate that the second operator is within a predetermined distance of the lift apparatus 116. Similarly, the ADAS 900 may be configured to alert a first operator of the second operator's proximity to a component of the refuse vehicle 100 before the first operator causes an operation of the refuse vehicle 100. For example, when the second operator is directly behind the refuse vehicle 100, the ADAS 900 may cause a distinct chime or alarm to sound to alert the first operator to avoid reversing the vehicle. Similarly, when the second operator is within a predetermined distance of the lift apparatus 116 (e.g., 3 feet, 4 feet, 5 feet, etc.), the ADAS 900 may be configured to cause a wearable of the first operator to light up, vibrate, or the like and may pause or prevent movement of the lift apparatus 116 until the second operator exits the proximity of the lift apparatus 116. In this way, the ADAS 900 may proactively pause or disable operations of the refuse vehicle 100 based on the location of the second operator. For example, in response to the second operator being detected within a predetermined distance of the lift apparatus 116, the ADAS 900 may disable and/or cause the operation of the lift apparatus 116 to momentarily stop until the second operator is detected a predefined minimum distance from the lift apparatus 116.

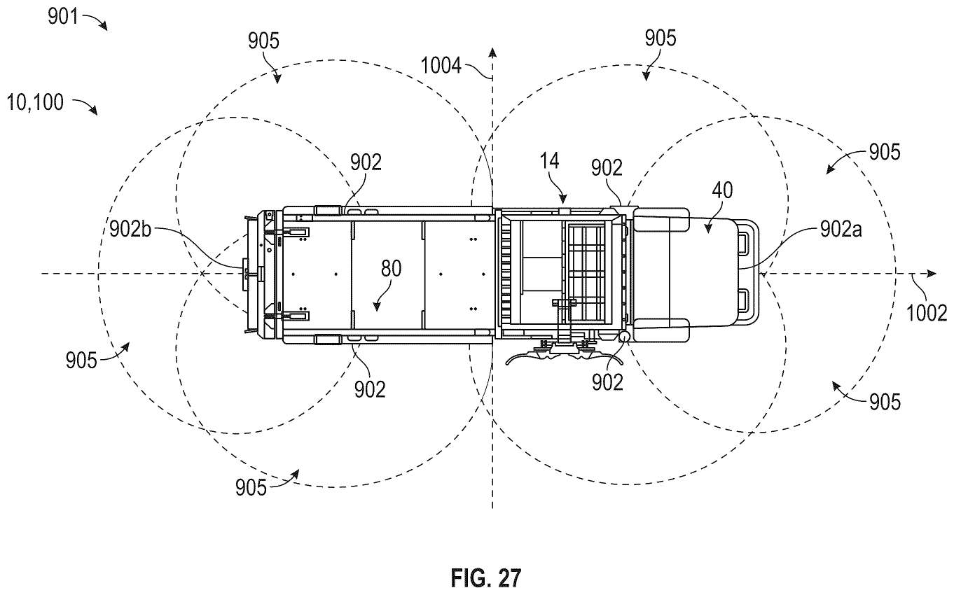

Turning to FIG. 27, the ADAS 900 may include a three-hundred-and-sixty-degree (360) camera system, shown as camera system 901 installed on the refuse vehicle 100. The camera system 901 may be communicatively coupled to the controller 102. Additionally, the ADAS 900 may include one or more components of the refuse vehicle 100 coupled or communicatively coupled to the ADAS 900 (e.g., a display 640, the alert system 122, a wearable configured to alert an operator when an individual is in the proximity of the refuse vehicle 100, that an object is approaching the refuse vehicle 100 at a certain velocity, etc.).

The camera system 901 includes sensors, shown as cameras 902. In some embodiments, the cameras 902 may be image sensors configured to capture live video and image data and provide the sensor data to ADAS 900. In some embodiments, each of the cameras 902 defines a field of view, shown as camera FOV 905. In some embodiments, the camera FOV 905 may be between approximately 100-360 degrees (e.g., the horizontal angle of view defined by the camera FOV 905). For example, the cameras 902 may each define a 160-degree FOV. The camera FOV 905 of each of the cameras 902 may overlap with one or two adjacent camera FOVs 905 to aid in stitching the various feeds together to form a composite 360-degree view around refuse vehicle 100. In some embodiments, the cameras 902 make up some and/or all of the sensors 526 that provide sensor data to controller 102. As shown in FIGS. 26-27, the cameras 902 may be integrated into the refuse vehicle 100 or the body 14 and components thereof. For example, the application kit 80 and/or the cab 40 of the refuse vehicle 100 may be modified such that the cameras 902 are integrated and installed into the body 14 (e.g., an outer surface, a panel, a case/cover/fixture mounted to the refuse vehicle 100, etc.) of the application kit 80 and/or the cab 40 so that the cameras 902 are protected and able to obtain appropriate image data.

The cameras 902 may be disposed at any number of locations throughout and/or around the refuse vehicle 100. In some embodiments, cameras 902 include a front camera 902a and a rear camera 902b as part of the camera system 901. While only six cameras 902, 902a, 902b are shown in FIG. 27, it should be understood that the number, position, and type of cameras 902, 902a, 902b in the camera system 901 might vary without departing from the scope of the present disclosure.

In FIG. 26, the refuse vehicle 100 is shown on a vehicle axis system with an x-axis 1002 and y-axis 1004. The x-axis 1002 is a horizontal axis parallel to the heading of the refuse vehicle 100 and in the forward direction of the refuse vehicle 100 such that it is also parallel to refuse vehicle 100's longitudinal plane of symmetry. The y-axis 1004 is perpendicular to the x-axis 1002 and the refuse vehicle 100's longitudinal plane of symmetry and is in the left direction of the vehicle of refuse vehicle 100. The z-axis 1006 is perpendicular to both the x-axis 1002 and the y-axis 1004 and is pointing upwards. In some embodiments, the front camera 902a and the rear camera 902b are approximately positioned on the x-axis 1002 and at approximately the same height from the ground as the other cameras 902 such that the cameras all lie in the approximately same z-plane parallel to and above the x-y plane.

In some embodiments, the cameras 902 are positioned according to one or more criteria to ensure image data from the cameras 902 can be combined to create a 360-degree composite view of the refuse vehicle 100 and its surroundings. The criteria can include angle, height, position relative to other cameras 902 in the camera system 901, position on the refuse vehicle 100, etc. For example, the cameras 902 integrated can have a 60 degree downward angle (e.g., a centerline extending through a body of the cameras 902 may intersect with a ground plane at a 60 degree angle), and be positioned at approximately the same height along the z-axis 1006 as measured from ground level and in an approximately horizontal plane that is parallel to the x-y plane (such that the cameras 902 are located along the same z-plane). The height of each camera 902 may be approximately equal to ensure the 360 composite video feed is useable. In some embodiments, the cameras 902 are positioned as high as possible on the refuse vehicle 100 while keeping each of the cameras 902 in the same z-plane (e.g., the highest location on the refuse vehicle 100 where this is mounting area available in the same z-plane on the application kit 80 and/or the cab 40 for all the cameras 902). In some embodiments, the cameras 902 may vary from the desired height by plus or minus 12 inches without interfering with the ability of the controller 102 to integrate the feeds from the cameras 902 into a 360-degree composite view.

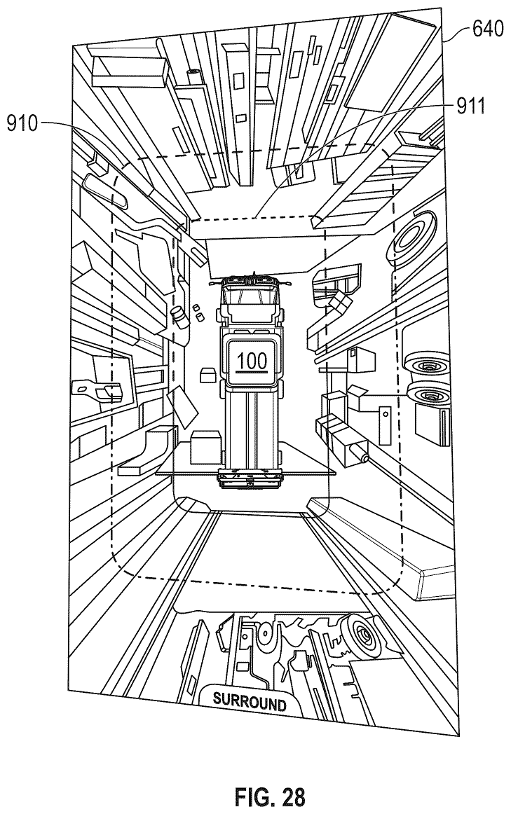

Turning to FIG. 28, an example display 640 is shown illustrating one embodiment of a view from the camera system 901. Although FIG. 28 depicts the refuse vehicle 100, the ADAS 900 and the camera system 901 may be incorporate onto any of the vehicle 10 in any of its forms described herein. As shown in FIG. 28, the camera system 901 and the controller 102 may generate a 360-degree view around the refuse vehicle 100. Additionally, the ADAS 900 may include any one and/or a combination of sensors 526 such as proximity sensors, infrared sensors, electromagnetic sensors, capacitive sensors, photoelectric sensors, inductive sensors, radar sensors, ultrasonic sensors, Hall Effect sensors, fiber optic sensors, Doppler Effect sensors, magnetic sensors, laser sensors (e.g., LIDAR sensors), sonar, and/or the like. The cameras 902 may include visible light cameras, full-spectrum cameras, image sensors (e.g., charged-coupled device (CCD), complementary metal oxide semiconductor (CMOS) sensors, etc.), or any other type of suitable object sensor or imaging device. Data captured by the sensors 526 and cameras 902 may include, for example, raw image data from one or more cameras (e.g., visible light cameras) and/or proximity data from one or more sensors (e.g., LIDAR, radar, etc.) that may be used to detect objects. Further, the proximity data may be used to create overlays on the display 640 such as outer zone 910 and inner zone 911. The overlays may indicate regions where individuals or objects may be located and designated as “safe” from the refuse vehicle 100 and may indicate regions where individuals or objects are “at risk.” For example, the ADAS 900 may generate and display the boundary of the inner zone 911 by outlining an area approximately 4-10 feet around the perimeter of the refuse vehicle 100 using image and proximity data. Similarly, the ADAS 900 may generate and display the boundary of the outer zone 910 by outlining an area approximately 8-20 feet from the refuse vehicle 100. The boundaries may be rectangular, rounded rectangles, ovular, or any other suitable shape and may be limited to one side or a portion of the perimeter around the refuse vehicle 100 (e.g., only display a 360 view or 180-degree view around the side lift assembly 160, etc.). In other embodiments, additional zones may be formed of varying shapes, at varying locations (e.g., a zone only surrounding the lift apparatus 116 by a radius of 4 feet, additional zones or zones overlapping the outer zone 910 and the inner zone 911, etc.).

The ADAS 900 may be configured to generate different warnings and/or signals based on the event and/or objected detected, the detected proximity from the refuse vehicle 100, and a concurrent operation of the refuse vehicle 100. For example, if the vehicle is idle, the ADAS 900 may generate no signal even if a pedestrian or operator enters the boundary of the outer zone 910 and/or inner zone 911. However, if the refuse vehicle 100 is performing a refuse collection operation such as operating the lift apparatus 116, the ADAS 900 may be configured to cause an alarm of the refuse vehicle 100 to sound upon detecting a pedestrian enter the outer zone 910, may cause a wearable to vibrate upon detecting an operator entering the inner zone 911, or the like.

The ADAS 900 and the controller 102 may be configured to detect a person or individual located within one or more zones. For example, the 360-degree camera system 901 may include motion detectors or other sensors in addition to image collecting sensors to identify an individual or operator near the refuse vehicle 100.

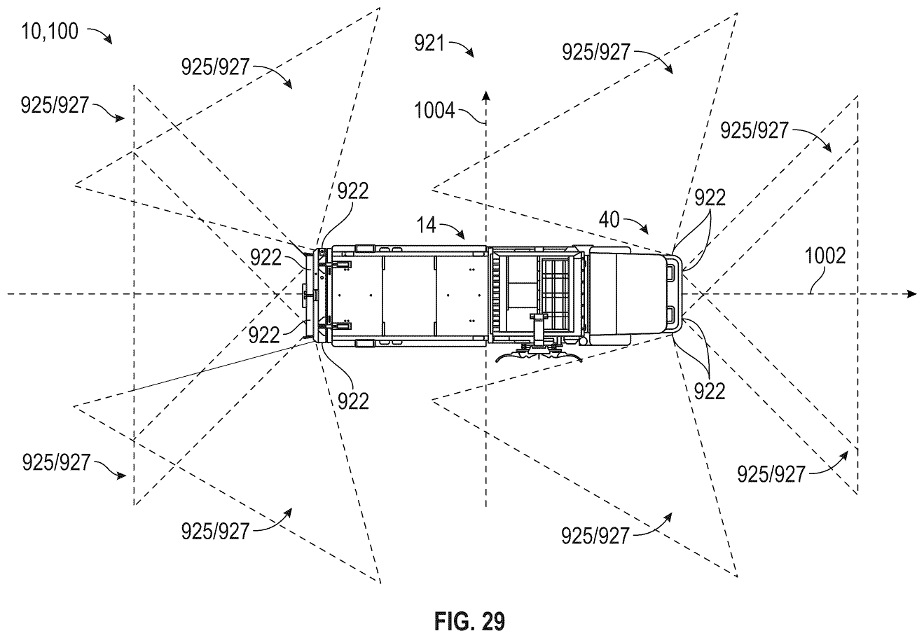

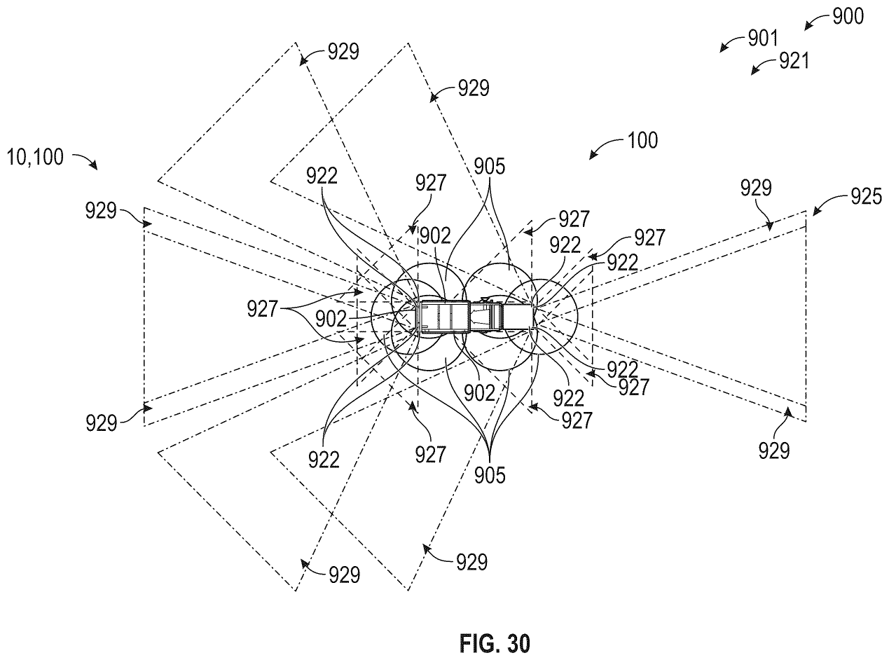

Turning to FIGS. 29 and 30, the ADAS 900 may also include a radar detection system, shown as radar system 921, configured to detect the position, speed, direction of travel, and/or acceleration of one or more objects external to the refuse vehicle 100. The radar system 921 includes radar sensors, shown as radar sensors 922 integrated into a body 14 and/or the cab 40 of the refuse vehicle 100, with field of views, shown as radar FOVs 925. In some embodiments, the radar sensors 922 are dual sensing radar sensors, and may have multiple radar FOVs 925, such as a first FOV for short range sensing, shown in FIG. 29 as short range FOV 927, and a second long range FOV 929, shown in FIG. 30, for long range sensing (e.g., extending further from the refuse vehicle 100 than short range FOV 927). In some embodiments, the short range FOV 927 is wider than the long range FOV 929 (e.g., the horizontal angle of view defined by the short range FOV 927 is greater than the horizontal angle of view defined by the long range FOV 929). For example, the short range FOV 927 can be approximately 45 degrees (e.g., the horizontal angle of view defined by the short range FOV 927) and the long range FOV 929 can be approximately 20 degrees. In some embodiments, the radar sensors 922 are single-distance radar sensors and have only a single FOV 925. In some embodiments, the radar sensors 922 are installed low to the ground in a substantially horizontal plane parallel to the x-y plane made by the x-axis 1002 and the y-axis 1004. For example, the radar sensors 922 can be placed between approximately 35 and approximately 43 inches off the ground on a horizontal plane. The radar sensors 922 are placed approximately horizontally to ensure proper functionality. Placing the radar sensors 922 low to the ground helps the radar sensors 922 detect smaller vehicles such as motorcycles, smaller pedestrians, nearby animals/pets, or the like. In some embodiments, the radar sensors 922 can provide sensor data to the ADAS 900 that indicates the existence of objects external to the refuse vehicle 100. The objects can include pedestrians, vehicles, refuse containers, animals/pets, obstructions, debris, etc. In some embodiments, the sensor data includes a position, direction of travel, speed, and/or acceleration of detected objects.

According to an exemplary embodiment, the radar system 921 includes two radar sensors 922 positioned on the front of the cab 40 and with the radar FOV 925 directed in a generally forward direction (e.g., a centerline of the radar FOV 925 is generally parallel to the x-axis 1002 or a forward direction of travel of the refuse vehicle 100). In some embodiments, two radar sensors 922 are positioned on the front corners of the cab 40 and positioned so that the radar FOV 925 is directed more toward the rear of refuse vehicle 100. In some embodiments, two radar sensors 922 are integrated into the rear of body 14 and positioned to face a generally rearward direction (e.g., a centerline of the radar FOV 925 is generally parallel to the x-axis and faces a reverse direction of travel of the refuse vehicle 100). In some embodiments, two radar sensors 922 can be integrated into the rear corners of body 14 and positioned at an angle relative to the two radar sensors arranged in the rear of the body 14. For example, the radar sensors 922 arranged in the rear corners of the body 14 may be orientated at an approximately 45-degree angle relative to the radar sensors 922 positioned to in the rear of the body 14. While the radar sensors 922 are shown in the configuration described above, it should be understood that the number and position of the radar sensors 922 in the radar system 921 may vary without department from the scope of the disclosure. For example, radar system 921 may only include front-facing and rear-facing radar sensors 922, rather than additional sensors in the corners. In other embodiments, the radar system 921 may also include a radar-LIDAR system 921 incorporating both radar and LIDAR devices.

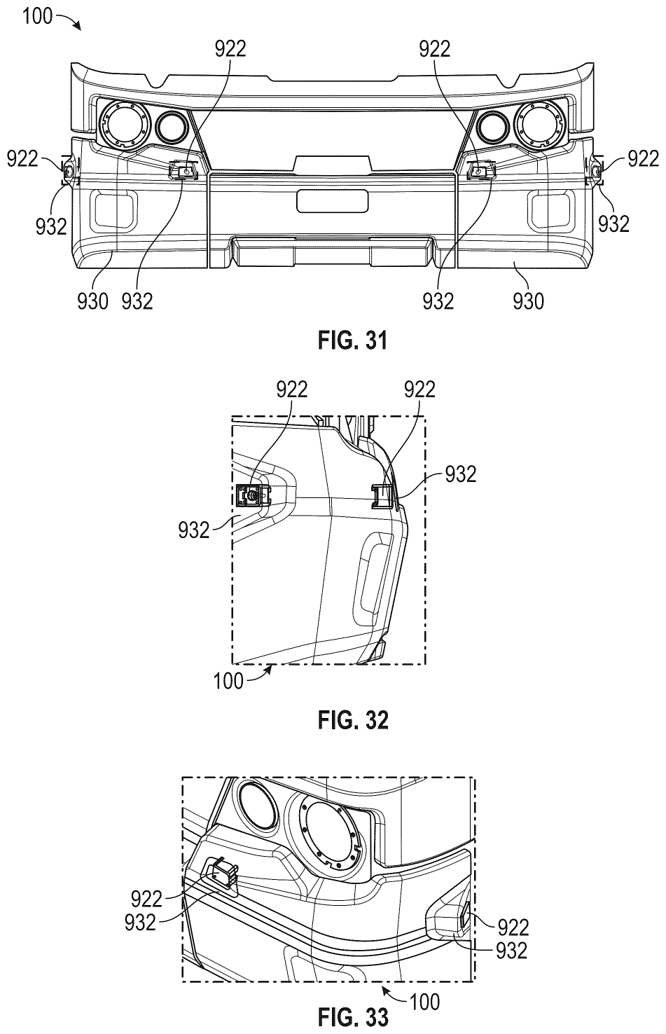

As shown in FIGS. 31-33, the radar sensors 922 can be integrated directly into the structure of refuse vehicle 100. For example, as shown in FIG. 31, the cab 40 may include four radar sensors 922 integrated into cab 40. In some embodiments, the radar sensors 922 are installed on an exterior of the cab 40 and positioned to sense outwardly (e.g., away from the cab 40). In some embodiments, the cab 40 includes one or more body panels, shown as body panels 930, which make up the exterior of the cab 40. In some embodiments, the body panel 930 may be a composite panel composed of multiple layers of material. For example, the body panels 930 may include a base material that provides structural integrity to the cab 40 and a cover material positioned directly in front of the radar sensors 922, shown as covers 932, which may be made from a material that is transparent to the emission from the radar sensors 922. In some embodiments, the body panels 930 can be fabricated from a composite panel largely constructed from metal, such as aluminum or steel, with the portions of the body panel 930 directly in front of the radar sensors 922, such as the covers 932, being fabricated from radar-transmissive materials (e.g., plastics, non-metallic, polycarbonate material, etc.).

In some embodiments, each of the radar sensors 922 is positioned behind a respective one of the covers 932 and attached to a wall of the cab 40. The radar sensors 922 can be positioned with a gap between the radar sensors 922 and the cover 932. In some embodiments, the radar sensors 922 must be placed within a maximum distance of any protruding metal feature (e.g., bumper) of cab 40. For example, the radar sensors 922 may be at most one inch behind a protruding metal bumper to minimize interference to the radar sensors 922 due to the metal bumper. As shown in FIGS. 31-33, the cab 40 may include two radar sensors on the front of the cab 40 and two radar sensors on the front corners of the cab 40. In some embodiments, the covers 932, while composed of a different material than the remainder of the body panel 930, are configured to resemble the external appearance of the body panel 930. Further, by being integrated into the cab 40, such as being installed behind a body panel 930 of the cab 40, the radar sensors 922 are protected from hazards such as dirt, water, and/or accidental contact that may move radar sensors 922 out of alignment or damage the radar sensors 922. Proper alignment of radar sensors 922 is important to the overall function of the radar system 921 and integrated sensors can provide a more stable platform.

In some embodiments, the radar sensors 922 may include an external case. The thickness of the external case may be limited to minimize the interference with the radar sensors 922 from the external case. For example, the external case may have a maximum thickness of 1.8 mm. In some embodiments, the radar sensors 922 are mounted with a gap between external case and an outer face of radar sensors 922. For example, the radar sensors 922 can be mounted with a 0.5 mm gap between the outer face of the radar sensors 922 and the external case. In some embodiments, the external case is made of plastic e.g., polycarbonate.

### Wearables

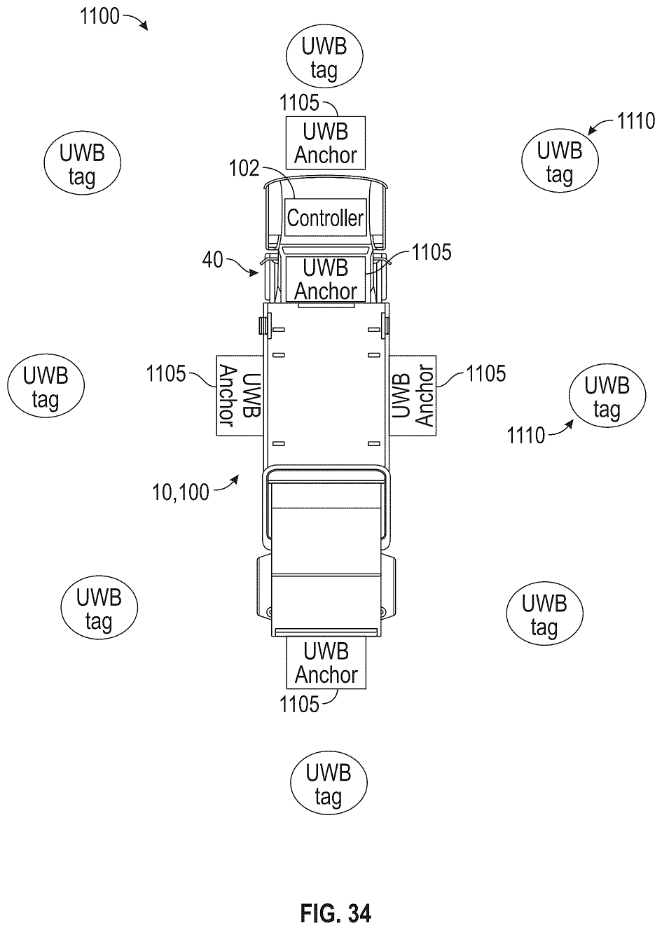

Turning to FIG. 34, a perspective view is shown of the vehicle 10 (e.g., the refuse vehicle 100) equipped with an operator location system (“OLS”) 1100. The OLS 1100 may be incorporated on a side-loading refuse vehicles 100, rear loading refuse vehicles 100, front loading refuse vehicles 100, mixer trucks 200, fire fighting vehicles 250, or any other forms of the vehicle 10 described herein. The OLS 1100 is configured to detect and monitor an operator's location in an area around the perimeter of the vehicle (e.g., the refuse vehicle 100). The OLS 1100 includes the controller 102, one or more OLS anchors 1105, one or more OLS tags 1110, and at least one output device (e.g., display 640). In some embodiments, the OLS 1100 may be a sub-component and/or subsystem of the ADAS 900, such that the ADAS 900 performs the object detection features discussed above as well as perform operator location tracking and monitoring associated with the OLS 1100.

The OLS 1100 may detect individuals (e.g., a second operator) within a designated proximity of the refuse vehicle 100 and provide a warning to a first operator regarding the location of the second operator with respect to the refuse vehicle 100. In this way, the OLS 1100 may monitor and alert a first operator (e.g., an operator in the cab 40) of the location of a second operator (e.g., an operator handling refuse containers 2 at a curb or adjacent to the refuse vehicle 100). The OLS 1100 may monitor and/or track the location of the second operator and send a signal indicative of the position of the second operator relative to the refuse vehicle 100 to a display such as the display 640, a display in the cab 40, the screen of a mobile device, etc. In this way, the ADAS 900 may inform the first operator of the location of the second operator or notify the first operator of hazards near the second operator. For example, in response to detecting a control signal sent to the lift apparatus 116, the OLS 1100 may cause a display of the refuse vehicle 100 or a wearable of the first operator to indicate that the second operator is within a predetermined distance of the lift apparatus 116. Similarly, the OLS 1100 may be configured to alert a first operator of the second operator's proximity to a component of the refuse vehicle 100 before the first operator causes an operation of the refuse vehicle 100. For example, when the second operator is located in a reverse path of the refuse vehicle 100, the OLS 1100 may cause a distinct chime or alarm to sound to alert the first operator to avoid reversing the refuse vehicle 100. Similarly, when the second operator is within a predetermined distance of the lift apparatus 116 (e.g., 3 feet, 4 feet, 5 feet, etc.), the OLS 1100 may be configured to cause a wearable of the first operator to light up, vibrate, or the like and may pause or prevent movement of the lift apparatus 116 until the second operator exits the proximity of the lift apparatus 116. In this way, the OLS 1100 may proactively pause or disable operations of the refuse vehicle 100 based on the location of the second operator.

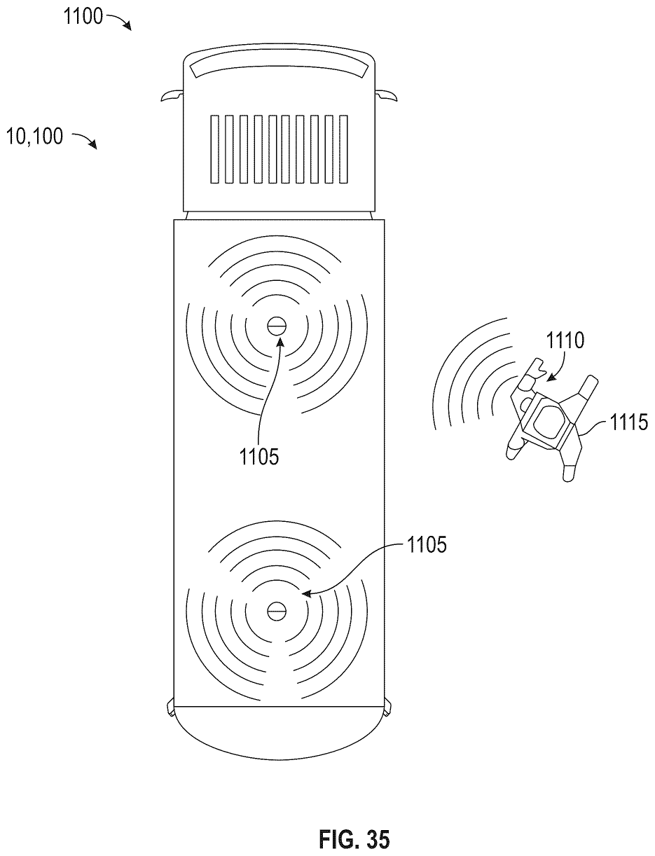

As shown in FIGS. 34-35, the OLS 1100 may be configured to collect data indicative of the location of one or more OLS tags 1110 around the refuse vehicle 100. The OLS tags 1110 may include proximity sensors, and preferably two-way ranging (TWR) ultra-wideband (UWB) sensors/tags. In other embodiments, the OLS tags 1110 may include other UWB, GPS, Wi-Fi, Bluetooth, radar, or other proximity tags/sensors. The OLS 1100 includes one or more OLS anchors 1105 coupled to the refuse vehicle 100 and configured to receive the signals indicative of the operator location from the OLS tags 1110. For example, as shown in FIG. 34, five OLS anchors 1105 are coupled to the refuse vehicle 100 in the cab 40 and at the front, rear, left, and right sides respectively. The location of the OLS tag 1110 may be precisely detected based on the time-of-flight and/or angle of arrival of signals/pulses sent to and/or received from the OLS anchors 1105 and the OLS tags 1110. In some embodiments, the accuracy of the determined location of the second operator may be within 10-50 centimeters of error or may be less than 10 centimeters of error.

As shown in FIG. 35, the OLS tag 1110 may be attached, fastened, sown in, or otherwise coupled to a wearable 1115 of the second operator. For example, wearables 1115 may include vests, hats, jackets, wristbands, waistbands, lanyards, rings, pins, accessories (e.g., mobile devices carried by the second operator), or any other suitable wearable or portable accessory configured to receive the OLS tag 1110. In the example shown in FIG. 35, the wearable 1115 includes a vest having the OLS tag 1110 sewn in or otherwise coupled to the material of the vest. Also, as shown in the FIG. 35, two OLS anchors 1105 may be positioned on the refuse vehicle 100. In some embodiments, the OLS 1100 may be configured to detect and display the location of an operator up to two-hundred meters away from the refuse vehicle 100. In this way, the OLS 1100 may be operable with systems and vehicle utilizing mobile apparatuses such as detachable/mobile carry cans, extendable hoses, and the like. In particular embodiments, e.g., a fire fighting vehicle, fire truck, or fire apparatus, the OLS 1100 may be configured to monitor and track the location of a second operator as they enter and carry out operations in a building, hazard zone, or location within two-hundred meters of the refuse vehicle 100.

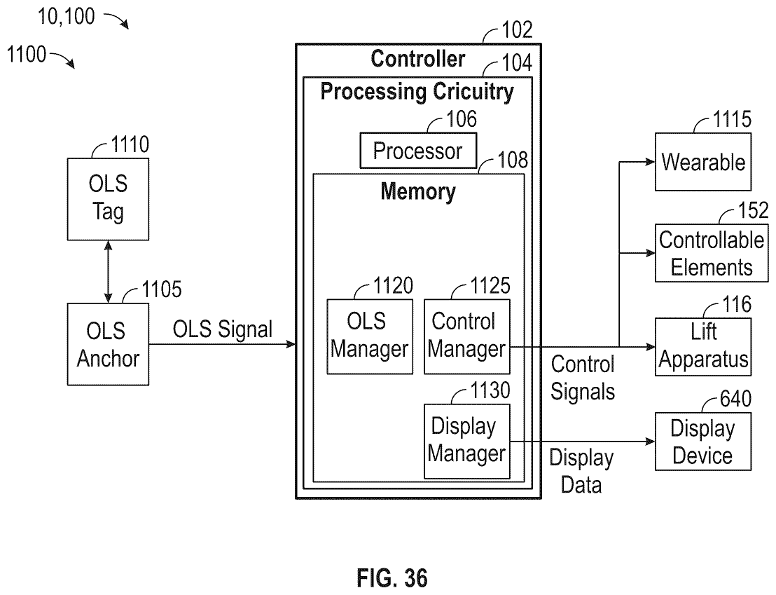

Turning to FIG. 36, the memory 108 of the controller 102 may include one or more circuits/hardware/devices to facilitate operation of the OLS 1100. For example, the memory 108 may include an OLS manager circuit 1120, an OLS control manager circuit 1125, and an OLS display manager circuit 1130.

The OLS manager circuit 1120 may obtain the OLS signals (e.g., UWB signals, location data, and the like) from the OLS anchors 1105 and/or OLS tags 1110. For example, the OLS manager circuit 1120 may receive the time of flight (ToF) and/or angle or arrival information from one or more UWB signals and determine the proximity and/or location of an UWB tag 1110 relative to a UWB anchor 1105. In this way, the OLS 1100 may constantly, periodically, etc. monitor and/or track the location of one or more operators as the operators maneuver around the refuse vehicle 100. The OLS manager circuit 1120 may be configured to send one or more signals to the OLS control manager circuit 1125 and/or the OLS display manager circuit 1130 to control one or more components of the refuse vehicle 100 based on the location of the operator or display the location of the operator on a display 640.

The OLS control manager circuit 1125 is configured to receive data indicative of the location of an operator relative to the refuse vehicle 100 and send a signal to at least one component of the refuse vehicle 100 (e.g., controllable elements 152, lift apparatus 116) or a wearable 1115 (e.g., a wearable worn or in the proximity of an operator within the cab 40). For example, in an autonomous or semi-autonomous operation mode, the OLS control manager circuit 1125 may send a signal to the lift apparatus 116 to stop raising and/or to pause a refuse collection operation in response to an OLS tag 1110 (e.g., an operator being located) within a predefined distance of the lift apparatus 116, an OLS anchor 1105 proximate to the lift apparatus 116, etc. Similarly, if an OLS tag 1110 (e.g., an operator wearing a wearable 1115 including an OLS tag 1110) is within a movement path of the refuse vehicle 100, the OLS control manager circuit 1125 may send a signal to controllable elements 152 (e.g., the driveline 110) to cause the refuse vehicle 100 to activate a brake, stop acceleration, or otherwise avoid striking the operator. Similarly, the OLS control manager circuit 1125 may send a signal to a wearable of another operator (e.g., a wearable of an operator inside the refuse vehicle 100) to alert the operator of the location of a second operator outside the refuse vehicle 100. For example, the OLS 1100 may determine that a second operator is located about 3 feet from the left side of the refuse vehicle 100 based on one or more signals received from an OLS tag 1110 of a wearable 1115 of the second operator. In response, the OLS 1100 may send a second signal to a wearable 1115 of a first operator (e.g., a driver or operator in control of the refuse vehicle 100) to alert the first operator of the position of the second operator. The second signal may cause haptic, audio, visual or other cues to alert the first operator (e.g., the left side of a vest of the first operator vibrating in response to the second operator being within about 3 feet of the left side of the refuse vehicle 100, a speaker to announce “operator two located in reverse path” in response to the second operator being 5 feet behind the vehicle, etc.).

The OLS display manager circuit 1130 may be configured to generate display data and operate a display 640 in the cab interior 42 or of the alert system 122 to provide the display data to an operator of the refuse vehicle 100 or a user that remotely controls or monitors the refuse vehicle 100. The display data may include images, a representation of the vehicle surroundings with a tracker/point/reticle/symbol indicating the position of an operator and a direction the operator is facing, or other indications of the location of the second operator relative to the refuse vehicle 100. Additionally, the OLS display manager circuit 1130 may incorporate a real-world or digital image of the area around the refuse vehicle 100. For example, the OLS display manager circuit 1130 may receive a 360-degree camera feed or image (e.g., from the ADAS 900) and superimpose location data, outline the location of the second operator, provide text identifying the second operator on the image/video feed, provide a callout indicating a calculated distance/proximity of the second operator from one or more components of the refuse vehicle 100, and display the same to the first operator, remote system, mobile device, display 640, etc.

Autonomous Disabling of Functions and/or Sensors

As discussed above, refuse vehicles 100 may be equipped with warning systems (e.g., the OODW system 700, the Advanced Driver Assistance Systems (ADAS) 900, the OLS 1100, etc.) that utilize sensors located around the refuse vehicle 100 to minimize the likelihood of human error impacting machine operations. The systems and methods disclosed herein may utilize these systems, their components (e.g., the camera system 901 of the ADAS 900, the radar system 921 of the ADAS 900, etc.), and/or other separate sensors 526 to ensure operator safety by disabling one or more functionalities of the refuse vehicle 100 when an operator or object is detected within range of a component of the refuse vehicle 100. For example, the refuse vehicle 100 may be equipped with a component and/or an alarm disabling system 1200.

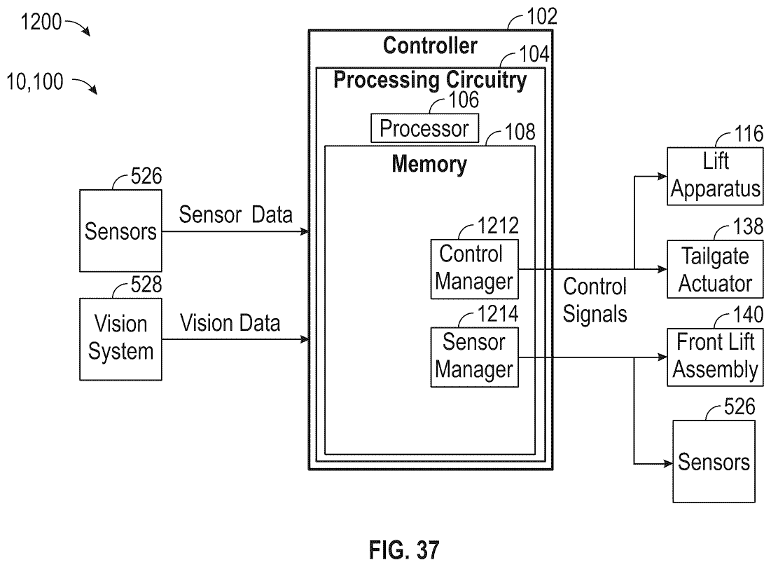

For example, turning to FIG. 37, the memory 108 of the controller 102 may include one or more items to facilitate disable, pause, slow down, or otherwise minimize the likelihood that individuals and operators are injured by mobile components of the refuse vehicle 10. For example, the memory 108 may include a control manager 1212 configured to avoid collisions/impacts between the refuse vehicle 10 components and individuals around the perimeter of the refuse vehicle 10. Further, the memory 108 may include a sensor manager 1214 configured to prevent “false positive” signals from sensor systems in response to expected operations of the components of the refuse vehicle 10 (e.g., preventing a false alarm caused by the lift apparatus 116 moving in front of a sensor 526 during each refuse collection operation).

The control manager 1212 is configured to control and/or prevent operation of at least one component of the refuse vehicle 100 in response to receiving a signal indicative of an individual located within the proximity of the refuse vehicle 100. The signal indicative of an individual located within the proximity of the refuse vehicle 100 may be received, for example, from one or more sensors 526, a component of one of the sensor systems discussed above, etc.

For example, in an autonomous or semi-autonomous operation mode, the control manager 1212 may send a signal to the lift apparatus 116 to stop raising and/or to slow movement of the refuse container 2 in response to movement detected within a range (e.g., 3 feet, 5 feet, 7 feet, etc.) of the lift apparatus 116. For example, if an operator outside the refuse vehicle approaches within the predefined range of the lift apparatus 116, the sensors 526 may send a signal to the control manager 1212, which may in turn prevent further operation of the lift apparatus 116 until the operator leaves the predefined range. The sensors 526 may include any of those described above. For example, the sensors 526 may include OLS tags 1110 (e.g., located on a wearable 1115) of an operator and respective OLS anchors 1105 configured to determine a position of the operator. In some embodiments, the control manager 1212 may be configured to prevent operation of the tailgate 136 in response to detecting an individual located within a predefined distance of the tailgate 136 (e.g., within a 6-foot cube behind the refuse vehicle 100, within a volume of space behind the refuse vehicle 100 through which the tailgate 136 moves, etc.). For example, the sensors 526 may include one or more radar sensors 922 with a radar FOV 925 directed behind the refuse vehicle 100. In this way, upon receiving a signal indicating an operator is within a predefined distance of the tailgate 136, the control manager 1212 may send a signal to stop the tailgate actuator 138, slow the tailgate actuator 138, or otherwise prevent operation of the tailgate 136 such that a collision between the tailgate 136 and the operator/individual is prevented.

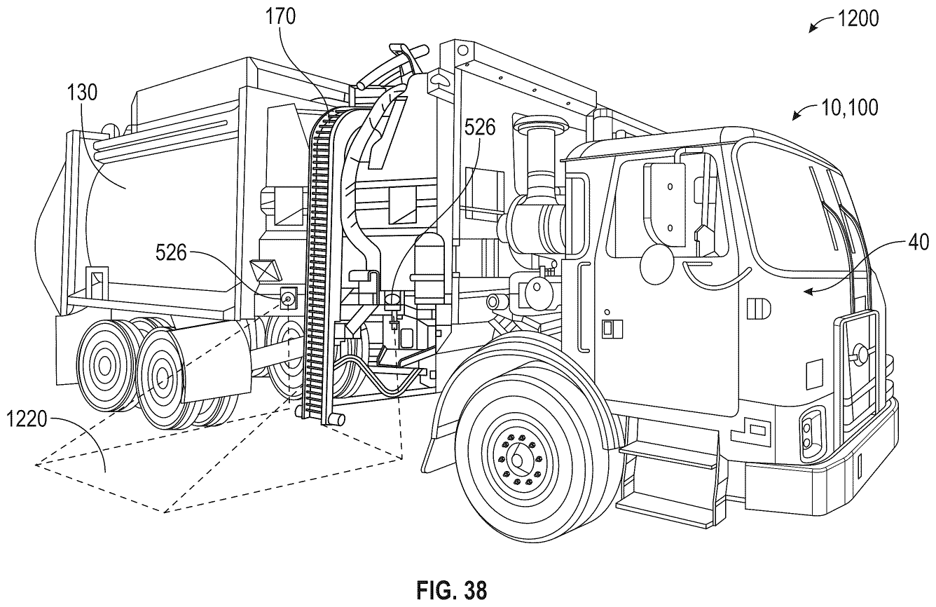

The sensor manager 1214 is configured to selectively disable one or more sensors 526 in response to operation of a component of the refuse vehicle 100 that may cause a “false positive” alert from the sensor 526. For example, turning to FIG. 38, a vehicle 100 is shown equipped with an exemplary component and/or alarm disabling system 1200. The sensor manager 1214 may receive a signal from the refuse vehicle 100 indicating operation of a component. The signal indicating operation of a component could include a signal that the lift apparatus 116 (e.g., side lift assembly 160) is operating/moving, a signal that the front lift assembly 140 is operating/moving, a signal that the tailgate actuator 138 is operating (e.g., the tailgate 136 is opening/closing), or the like. The control manager 1212 be communicatively coupled to a sensor 526, shown as two side proximity sensors 526 (e.g., radar sensors 922, cameras 902, etc.). The control manager 1212 may detect and/or receive a signal indicating that an individual is located within a hazard zone 1220 wherein operation of the lift apparatus 116 (e.g., side lift assembly 160) may result in collision between the refuse vehicle 100 and the individual. Accordingly, the control manager 1212 may be configured to cause the vehicle components to stop operating or slow operation until no individual is detected within the hazard zone 1220.

Further, when components of the refuse vehicle 100 are in operation, the components may travel along an operation path defined between a non-actuated position and a fully-actuated position. For example, turning back to FIG. 19, the front lift assembly 140 is shown in a non-actuated position in state (1), wherein the front lift assembly 140 is fully lowered towards the ground. As shown in states (3) and (4), the front lift assembly 140 may be raised towards a fully-actuated position (e.g., a position wherein the front lift assembly 140 is fully actuated such that refuse empties into the compartment 130). As the components (e.g., the front lift assembly 140) transition between the non-actuated position and the fully-actuated position, one or more parts thereof may travel through detection zones of various sensors 526 of the refuse vehicle 100 (e.g., radar FOV 925). To avoid operation of components of the refuse vehicle 100 triggering the various detection systems described above, the sensor manager 1214 may be configured to receive a position of one or more vehicle components (e.g., a lift actuator of the lift assembly 140) and prevent an alarm associated with a respective vehicle component entering a sensor detection zone. In other embodiments, the vision system 528 of the refuse vehicle 100 may be configured to detect the location of an operator within range of a component of the refuse vehicle 100, and in response, the control manager 1212 may stop, pause, slow, or otherwise mitigate the operation to prevent injury to the operator.

For example, a radar sensor 922 on the front of the refuse vehicle 100 may be configured to momentarily turn off or be disabled by the controller 102 when the front lift assembly 140 is activated so that the front lift assembly 140 passing over the radar FOV 925 of the radar sensor 922 does not activate the radar detection system of the refuse vehicle 100. In another example, operation of one or more lift apparatuses 116 of the refuse vehicle 100 may result in one or more sensors turning off or one or more systems ignoring a signal when the lift apparatus 116 (e.g., the front lift assembly 140) crosses into the sensor detection zone. In some embodiments, an angle sensor or encoder may be coupled to the front lift assembly 140. The front lift assembly 140 may pass through a detection zone of a sensor 526 when the angle sensor indicates that the front lift assembly 140 is within a predefined range of motion along its lifting path. Accordingly, the sensor manager 1214 may selectively deactivate the sensors 526 that would detect the front lift assembly 140 (e.g., front facing radar sensors 922) while the angle sensor indicates that the front lift assembly 140 is in the predefined range. Alternatively or additionally, the sensor manager 1214 may detect that the front lift assembly 140 is within the predefined range along the lifting path based on a position sensor that is coupled to one or more of the lift arm actuators 144 and detects the extension and retraction thereof, and thereby a position of the front lift assembly 140.

In other embodiments, the sensor manager 1214 may lower the volume of an alarm associated with the sensor 526 detecting the vehicle component, may cause a different alarm or notification to display to an operator (e.g., flashing a light while the alarm associated with the radar system 921 sounds to indicate that the front lift assembly 140 is in the detection zone, causing a separate noise to sound when the front lift assembly is detected by the front radar sensor 922 as an alterative or in addition to the standard alarm, etc.). In this way, the refuse vehicle 100 may be configured to disable/alter/or otherwise mitigate “false positive” alarms from one or more systems, system components, and/or sensors 526 during one or more functionalities of the refuse vehicle 100.

### Detection of Approaching Objects

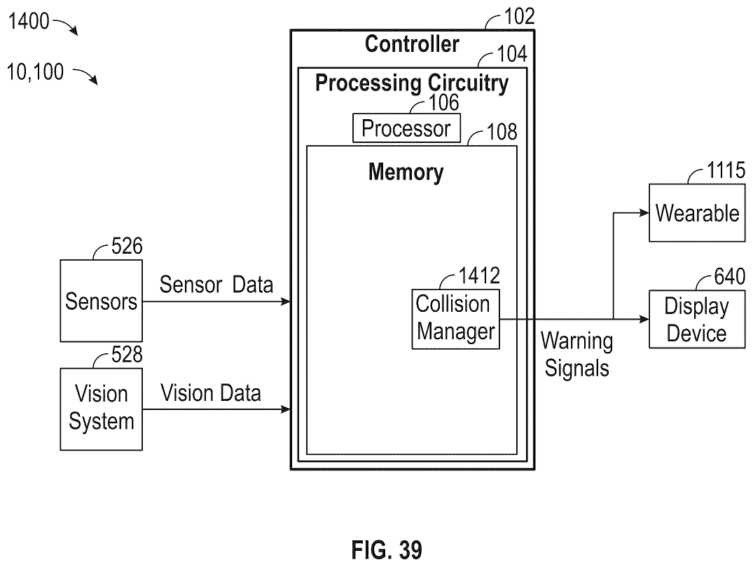

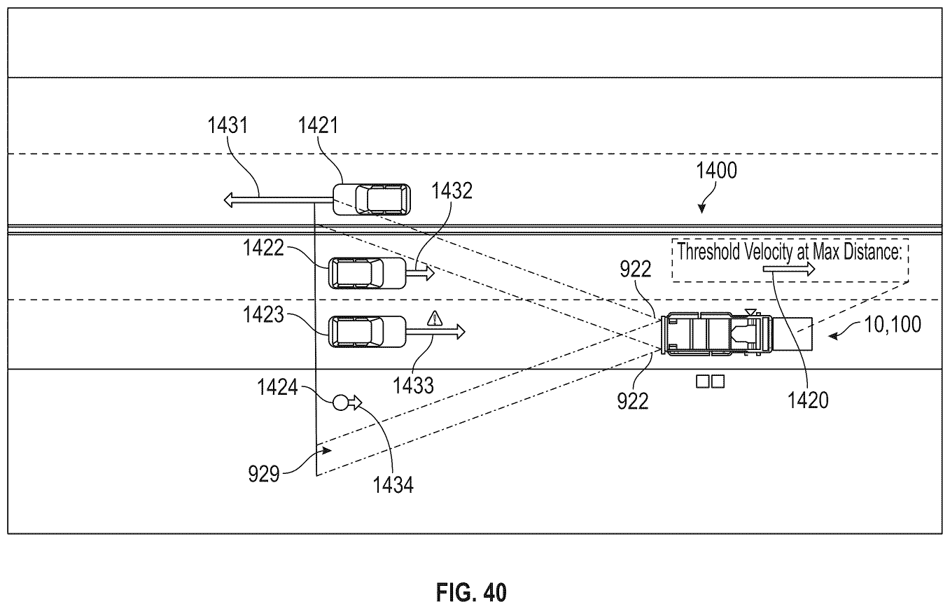

The vehicle 10 and the systems thereof (e.g., the OODW system 700, the Advanced Driver Assistance Systems (ADAS) 900, the OLS 1100, etc.) may also be configured to minimize the likelihood of bystander/civilian error impacting machine operations and operator safety. As shown in FIGS. 39 and 40, the vehicle 10 (e.g., the refuse vehicle 100, the mixer truck 200, the fire fighting vehicle 250, etc.) may be equipped with a collision mitigation system 1400 that utilizes the detection systems discussed above, their components (e.g., the camera system 901 of the ADAS 900, the radar system 921 of the ADAS 900, etc.), and/or other separate sensors 526 to detect an approaching object and provide a warning to the operator (e.g., of a possible impending rear-end collision).

For example, turning to FIG. 39, the memory 108 of the controller 102 includes a collision mitigation system 1400 having a collision manager 1412 configured to detect a potential collision event and provide a warning in response to detecting the potential collision event. In some embodiments, the controller 102 receives sensor data from one or more sensors 526 (e.g., radar sensors, LIDAR sensors, etc.) and/or vision data from the vision system 528 (e.g., via cameras, video feed, etc.). The collision manager 1412 may receive the sensor data and/or vision data and determine a collision risk value. For example, the collision risk value may be based on the speed of an object, the direction of motion of an object, the size of an object, the distance between the object and the vehicle 10, and other relevant factors. Based on the determined collision risk value, the collision manager 1412 may determine to send one or more warning signals to a wearable 1115 and/or a display 640 of the vehicle 10.

For example, in some embodiments, the collision manager 1412 is configured to determine a percentage likelihood that a detected object will collide with the vehicle 10. The percentage likelihood may be determined based on an algorithm, a heuristic, a machine learning model, an AI model, or other suitable methods. For example, the collision manager 1412 may determine that the percent likelihood of a collision increases as the detected object's speed, size, and proximity to the vehicle 10 increase and the object's angle of travel relative to the vehicle 10 degreases (e.g., zero degrees indicating that the vehicle is traveling in the same direction as the vehicle 10, ninety degrees indicating that the vehicle is travelling perpendicular relative to the refuse vehicle 100, etc.). Similarly, the collision manager 1412 may determine that the percent likelihood of a collision decreases as the detected object's speed, size, and proximity decrease and the angle of travel relative to the vehicle 10 increases. In other embodiments, the collision manager 1412 is configured to alert an operator of a possible collision event by detecting whether an object is traveling towards the vehicle 10 above a threshold velocity from a designated direction. The threshold velocity may vary based on the distance of the object from the vehicle 10. For example, for a distance far away from the vehicle 10 (e.g., 600 feet, 500 feet, etc.) the threshold velocity may be relatively high (e.g., above 75 mph given that the stopping distance of a standard vehicle at 75 mph is approximately 360 feet). Similarly, for a relatively small distance between the detected object and the vehicle (e.g., 80 feet, 60 feet, a distance where comparatively less space is available for the object to slow down/avoid the refuse vehicle 100), the threshold velocity may be relatively low (e.g., 20 mph, 30 mph, etc.).

Additionally, the collision manager 1412 may receive sensor data from the sensors 526 and/or vision data from the vision system 528 and classify the data as indicative of various collision events. For example, the collision manager 1412 may determine that the data is indicative of the following collision event classifications: “no collision”, “potential rear end collision with standard sedan”, “potential side swipe”, “potential collision with 18-wheeler”, “potential minor/low velocity collision”, and the like. Further, the collision manager 1412 may be configured to cause different alerts, alarms, notifications, etc. based on the respective detected collision event classification. For example, the collision manager 1412 may receive image data from the vision system 528 indicating that an objected detected behind the vehicle 10 is an 18-wheeler, construction vehicle, municipal bus, etc. The collision manager 1412 may also receive sensor data from one or more sensors 526 (e.g., radar sensors) indicating that the detected object is travelling at 80 mph, is approximately 200 feet away from the vehicle 10, and is directly behind the vehicle 10. The collision manager 1412 may determine via the algorithm, heuristic, machine learning model, etc. that the data is indicative of a collision event classification of “major collision potential”, “potential collision with 18-wheeler,” etc. Accordingly, the collision manager 1412 may cause an urgent alert, alarm, or notification to alert the operator (e.g., entire wearable vest heavily vibrating and flashing, loud alarm sounding, etc.). Similarly, the collision manager 1412 may receive sensor data indicating that a standard sized vehicle is approaching at a speed of 40 mph at a distance of 60 feet from the refuse vehicle 100. The collision manager 1412 may determine that the data is indicative of a collision event classification such as “possible rear end collision.” Accordingly, the collision manager 1412 may cause an alarm to sound. In other embodiments, the collision manager 1412 may determine that no collision is probable but may still cause a notification or alarm (e.g., a light to shine/flash, an indicator to illuminate, etc.) to alert the operator of the presence of the detected object.

With specific reference to FIG. 40, a diagram is shown illustrating an example operation of a vehicle 10 equipped with a collision mitigation system 1400. In some embodiments, the diagram of FIG. 40 is provided on a display (e.g., of the alert system 122, the display 640, another display within the cab 40, or an external device arranged externally to the cab 40). As shown in FIG. 40, the vehicle 10 may be equipped with sensors 526 such as rear radar sensors 922 having a long range FOV 929 configured to detect and alert the operator of possible rear-end collisions (e.g., a rear-end collision occurring while the vehicle 10 is stopping or stopped and conducting an operation). The collision manager 1412 may be configured to detect a threshold velocity at a maximum distance away from the refuse vehicle 100. For example, the threshold velocity 1420 represented by the white arrow may include 75 mph or greater in the direction of the refuse vehicle 100 at a distance between 250-400 feet behind the refuse vehicle 100. Further, the collision mitigation system 1400 may detect one or more objects behind the refuse vehicle 100 such as a first object 1421 (e.g., sedan 1421), a second object 1422 (e.g., sedan 1422), a third object 1423 (e.g., sedan 1423), a fourth object 1424 (e.g., pedestrian 1424) and so on. The collision mitigation system 1400 may associate each detected object with a respective velocity. The collision mitigation system 1400 may then compare each detected object and detected velocity to the threshold velocity at a particular distance and determine whether to cause an alarm that alerts the operator of a possible collision.

As shown in FIG. 40, each object within the field of view of the radar sensors 922 is overlayed with a vector relating to the direction of travel of the object and a speed of travel of the object. For example, the collision mitigation system 1400 may detect that the first object 1421 is travelling at a first velocity 1431 with a magnitude above the threshold velocity 1420, but in an opposite direction. Accordingly, the collision mitigation system 1400 may determine not to cause an alarm or associate the first object 1421 with a potential collision event. Similarly, the collision mitigation system 1400 may detect that the second object 1422 and the fourth object 1424 are travelling at a respective second velocity 1432 and fourth velocity 1434 velocities below the threshold velocity 1420, and, accordingly, may determine not to cause an alarm or associate the second object 1422 and the fourth object 1424 with a potential collision event. Further, the collision mitigation system 1400 may detect that the second object 1422 and/or the fourth object 1424 are traveling in a direction that will avoid the refuse vehicle 100 (e.g., the objects may pass beside rather than collide with the vehicle 10). In response, the collision mitigation system 1400 may cause no alarm or may indicate that an object may pass on the respective side (e.g., cause a left arrow to illuminate to alert the operator that sedan 1422 is passing by in the left lane). Further, the collision mitigation system 1400 may detect that the third object 1423 is travelling at a third velocity 1433 above the threshold velocity 1420 and further in the direction of the vehicle 10. Accordingly, the collision mitigation system 1400 may determine cause an alarm to sound within the vehicle 10 and associate the third object 1423 with a potential collision event and alert the operator. Additionally, the collision mitigation system 1400 is configured to provide a warning symbol above the symbol for the third velocity 1433.

### Customer Support and Training System

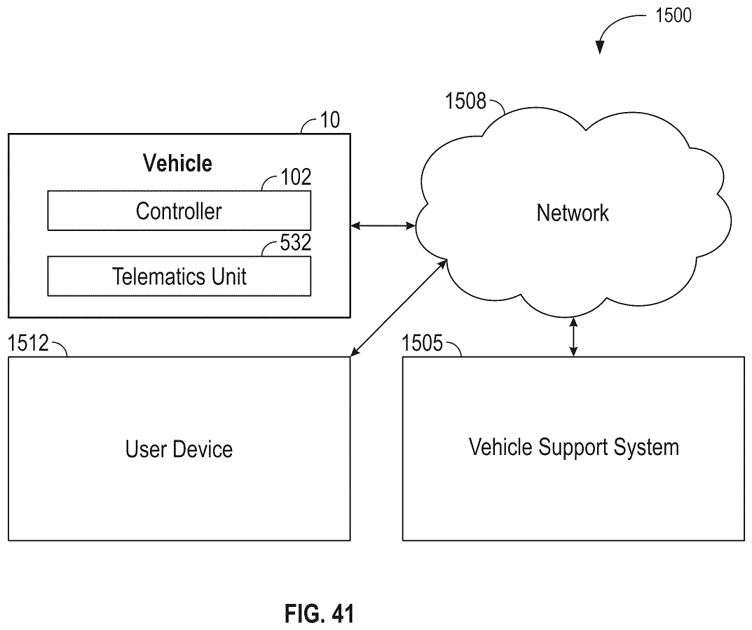

Turning to FIG. 41, the vehicle 10 and the systems thereof (e.g., the OODW system 700, the Advanced Driver Assistance Systems (ADAS) 900, the OLS 1100, the collision mitigation system 1400, etc.) may also be configured to operate with a customer support and training system 1500. For example, operators, customers, businesses, and other individuals or entities interacting with the vehicle 10 may require training or assistance operating the multiple features of the vehicle 10, such as the features, functions, and systems disclosed herein. The customer support and training system 1500 is configured to simplify customer support through a support network including a training engine that stores data associated with the technical features of the vehicle 10 (e.g., technical manuals related to the vehicle 10, training presentations related to the vehicle 10, schematic diagrams of the vehicle 10, etc.). The support network, via the training engine, can receive inputs such as user queries regarding the vehicle, generate informative replies responsive to the user queries, and output the replies (e.g., training information and/or direct answers to the queries) to provide customer/operator support.

As shown in FIG. 41, an example customer support and training system 1500 may include the vehicle 10, a vehicle support system 1505, a network 1508, and a user device 1512. The vehicle 10 may include any vehicle discussed herein or information associated with any 100 discussed herein. Further, the customer support and training system 1500 may be communicatively coupled to the controller 102 and/or the telematics unit 532 of the vehicle 10. In this way, the customer support and training system 1500 may receive, track, or other log data associated with operations of the vehicle 10 (e.g., real time operation data) and store/update its database with information regarding real world vehicle operations, routes, operating conditions, and the like.

The components of the system 1500 (e.g., the vehicle 10, the user device 1512, and/or the vehicle support system 1505) may communicate with one another directly and/or indirectly across the network 1508 (e.g., intranet, Internet, VPN, a cellular network, a satellite network, etc.). In some embodiments, the components of the system 1500 communicate wirelessly. By way of example, the system 1505 may utilize a cellular network, Wi-Fi, Bluetooth, LTE, near field communication (NFC), LoRA communication, satellite communication, infrared communication, radio, or other types of wireless communication. In other embodiments, the system 1500 utilizes wired communication.

The user device 1512 may include any device that allows a user to transmit and/or receive information or other data to/from the vehicle support system 1505 (e.g., via network 1508). Examples of user devices include, but are not limited to, mobile phones, electronic tablets, laptops, desktop computers, workstations, and other types of electronic devices. Generally, user device 1502 may include at least a display for presenting information to a user and a user input device for receiving user inputs. The user input components of user device 1502 may include, for example, a keyboard, buttons, a touchscreen, talk-to-text inputs, voice commands, photographs of vehicle components, etc. In one example, user device 1502 is a smart phone or tablet having a touchscreen display configured to present an application or other user interface for receiving a user query (e.g., a question related to a vehicle 10, a request for training/support information related to a component or system of the vehicle 10, etc.) and providing a reply to the query (e.g., an answer generated or otherwise sent from the vehicle support system 1505).

In some embodiments, a user of user device 1502 (e.g., a customer, an operator of the refuse vehicle 100, etc.) may input one or more data objects, natural language inputs, text strings, or the like to define a query to the vehicle support system 1505. The query may, for example, include a natural language question/request for information such as “How do I manually operate the fire mitigation device?”, “What are the features of the operator location system?”, “Explain how to operate the side collection arm.”, or other suitable queries. In other embodiments, the query may include a photograph of a component of the vehicle 10 about which the user seeks information/training data.

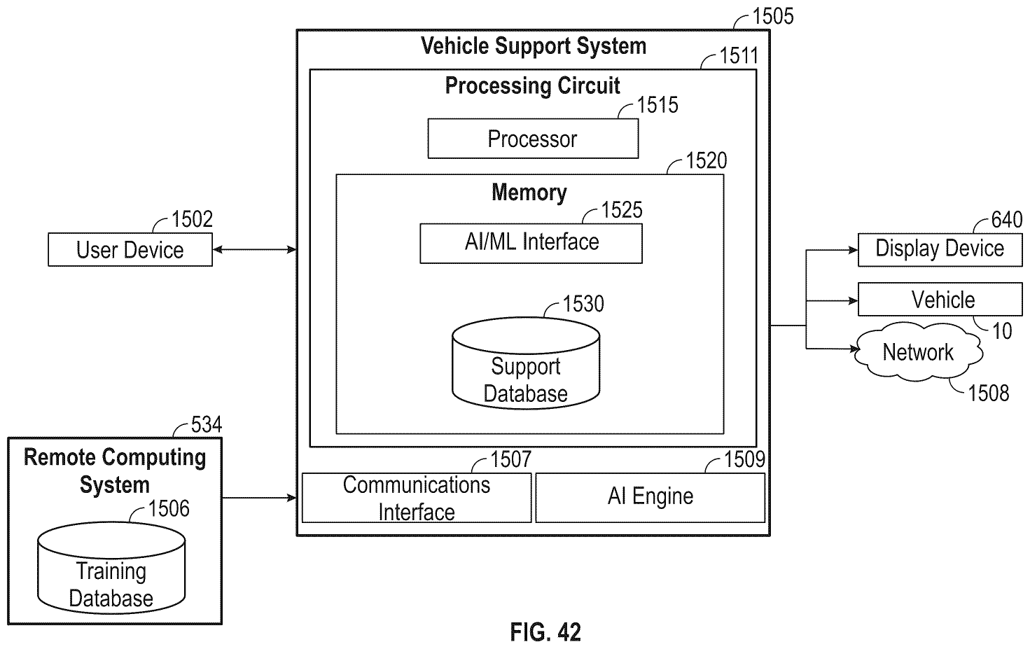

The vehicle support system 1505 is configured to receive the user query, generate a reply responsive to the query, and provide the reply to the user. Turning to FIG. 42, a block diagram of an exemplary vehicle support system 1505 is shown, according to an example embodiment. For example, the vehicle support system 1505 may be configured to train a model based on training data, manuals, part schematics, and the like associated with the ref vehicle 10. In this way, an algorithm, an AI model, a large language model (LLM), or other suitable heuristics may be included in the vehicle support system 1505 and utilized to generate replies responsive to user queries in order to train, support, or otherwise inform a user about details of the vehicle 10, its systems, components, and functionalities.

As shown in FIG. 42, the vehicle support system 1505 may be communicatively coupled to a remote computing system 534, a display 640, the vehicle 10, a user device 1502 and/or the network 1508. The remote computing system 534 may include a computer system associated with a provider of the vehicle support system 1505 and/or the vehicle 10. For example, the remote computing system 534 may include the computer system of a manufacturer of the vehicle 10, a provider of refuse collection services, an entity which trains operators of vehicle 10, and the like. As shown in FIG. 42, the remote computing system 534 may include a training database 1506. The training database 1506 may include training manuals, schematic diagrams, training videos, support documents/memoranda, instruction manuals, operation guides, regulatory data, or other information related to the functionalities, components, and operation of the vehicle 10. The remote computing system 534 may selectively provide information from the training database 1506 to the vehicle support system 1505, for example, via the communications interface 1507 of the vehicle support system 1505. In this way, and as discussed below, an AI engine 1509 may train, store, or otherwise generate content or analyze the data stored in or provided from the training database 1506.

The communications interface 1507 is configured to facilitate communications with external computing systems (e.g., user devices 1502, the remote computing system 534, the network 1508, etc.) and with vehicle 10. Communications interface 1507 may support any kind of wireless standard (e.g., 802.11 b/g/n, 802.11a, etc.) and may interface with any type of external computing system including wireless communication capability (e.g., cellular, Wi-Fi, etc.). Communications interface 1507 may be any type of capable module (e.g., a CL-T04 CANect® Wi-Fi Module manufactured by HED Inc., etc.) configured to support wireless communications with the external computing systems and other vehicles 10. In one embodiment, the external computing systems communicate with vehicle support system 1505 via Wi-Fi. In other embodiments, the communications between the external computing systems and/or vehicles 10 and the vehicle support system 1505 may be supported via CDMA, GSM, or another cellular connection. In still other embodiments, another wireless protocol is utilized (e.g., Bluetooth, Zigbee, radio, etc.).

The AI engine 1509 is configured to receive data associated with one or more vehicles 100 and the operation thereof. For example, the AI engine 1509 may include an LLM configured to train or process data from the training database 1506 of the remote computing system 534. The AI engine 1509 is further configured to receive queries including requests for vehicle data, support, training advice, and the like. In response, the AI engine 1509 is configured to generate a reply to the request. The reply to the request may contain material generated by the AI engine 1509 responsive to the query. For example, a user query may request training tips or tutorials regarding operation of the front lift assembly 140. Accordingly, the AI engine 1509 may utilize data stored in the training database 1506 and/or the memory 1520 to generate a reply including an explanation of the front lift assembly 140, a list of steps for operating the front lift assembly 140, links or manuals regarding the front lift assembly 140 and the sensors/systems interoperable with the front lift assembly 140, etc. The vehicle support system 1505 may store, log, or otherwise receive the generated reply from the AI engine 1509 in a support database 1530 of the memory 1520.

For example, the AI engine 1509 may communicate with the memory 1520 via the AI interface 1525. The AI interface 1525 is configured to allow the AI engine 1509 to train, review, or otherwise access the data contained in the support database 1530. The vehicle support system 1505 may also store user queries in the support database 1530. In this way, the AI engine 1509 may train, analyze, and otherwise learn or generate additional content based on not only the data in the training database 1506, but also the data previously generated by the AI engine 1509 or provided as user queries. The vehicle support system 1505 may also send a prompt to the user device requesting that users rank or score the accuracy of a particular reply. In this way, the vehicle support system 1505 and the AI engine 1509 may improve the accuracy of responses to the same or repeated queries based on the score associated with past answers to that query. As shown in FIG. 42, once the reply responsive to the query has been generated or otherwise identified, the reply may be communicated to the display 640, the vehicle 10, to the network 1508, and/or to the user device 1502.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A vocational vehicle comprising:
a chassis;
a cab supported by the chassis;
a body supported by the chassis and defining a compartment;
a lift assembly coupled to the body so that the lift assembly is configured to move between a lowered position and a raised position along a path;
a sensor defining a field of view that at least partially includes the path of the lift assembly; and
a vehicle control system in communication with the lift assembly and the sensor, the vehicle control system including a controller having a processor and at least one memory, the controller being configured to:
detect that the lift assembly is activated to move; and
disable the sensor.

2. The vocational vehicle of claim 1, wherein the sensor is a radar sensor.

3. The vocational vehicle of claim 1, wherein the sensor is coupled to an exterior of the cab.

4. The vocational vehicle of claim 3, wherein the sensor is arranged behind a cover.

5. The vocational vehicle of claim 1, wherein the controller is configured to activate the sensor in response to the lift assembly being deactivated so that the lift assembly stops moving.

6. The vocational vehicle of claim 1, wherein the controller is configured to detect that the lift assembly is activated to move based on an output from an angle sensor.

7. The vocational vehicle of claim 6, wherein the controller is configured to disable the sensor when the angle sensor indicates that the lift assembly is within a predetermined range along the path.

8. The vocational vehicle of claim 7, wherein the controller is configured to activate the sensor in response to the angle sensor indicating that the lift assembly is outside of the predetermined range along the path.

9. The vocational vehicle of claim 1, wherein the controller is configured to detect that the lift assembly is activated to move based on a position of a lift arm actuator of the lift assembly.

10. The vocational vehicle of claim 9, wherein the controller is configured to disable the sensor when the lift arm actuator is within a predetermined range along the path.

11. A refuse vehicle comprising:
a chassis;
a cab supported by the chassis;
a body supported by the chassis and defining a refuse compartment;
a lift assembly coupled to the body and including a lift arm actuator that is configured to move the lift assembly between a lowered position and a raised position along a lifting path;
a radar sensor defining a field of view that at least partially includes the lifting path of the lift assembly; and
a vehicle control system in communication with the lift assembly and the radar sensor, the vehicle control system including a controller having a processor and at least one memory, the controller being configured to:
determine that the lift arm actuator is moving the lift assembly along the lifting path; and
disable the radar sensor while the lift arm actuator is moving the lift assembly along the lifting path.

12. The refuse vehicle of claim 11, wherein the radar sensor is coupled to an exterior of the cab.

13. The refuse vehicle of claim 12, wherein the radar sensor is arranged behind a cover.

14. The refuse vehicle of claim 11, wherein the controller is configured to activate the radar sensor in response to the lift arm actuator being deactivated so that the lift assembly stops moving.

15. The refuse vehicle of claim 11, wherein the controller is configured to detect that the lift arm actuator is moving the lift assembly along the lifting path based on an output from an angle sensor.

16. The refuse vehicle of claim 11, wherein the controller is configured to detect that the lift arm actuator is moving the lift assembly along the lifting path based on a position of the lift arm actuator.

17. A refuse vehicle comprising:
a chassis;
a cab supported by the chassis;
a body supported by the chassis and defining a refuse compartment;
a lift assembly coupled to a front portion of the body and including a lift arm actuator that is configured to move the lift assembly between a lowered position and a raised position along a lifting path;
a radar sensor defining a field of view that at least partially includes the lifting path of the lift assembly;
a position sensor configured to sense a position of the lift assembly; and
a vehicle control system in communication with the lift assembly, the radar sensor, and the position sensor, the vehicle control system including a controller having a processor and at least one memory, the controller being configured to:
determine, based on the position sensor, that the lift arm actuator is moving the lift assembly along the lifting path; and
disable the radar sensor when the lift assembly is within a predetermined range along the lifting path.

18. The refuse vehicle of claim 17, wherein the radar sensor is coupled to an exterior of the cab.

19. The refuse vehicle of claim 18, wherein the radar sensor is arranged behind a cover.

20. The refuse vehicle of claim 17, wherein the controller is configured to activate the radar sensor in response to the position sensor indicating that the lift assembly is outside of the predetermined range along the lifting path.
